(19) United States
(12) Patent Application Publication
(10) Pub. No.: US 2010/0070888 A1
(43) Pub. Date: Mar. 18, 2010

(54) DEVICE AND METHOD FOR GRAPHICAL USER INTERFACE HAVING TIME BASED VISUALIZATION AND MANIPULATION OF DATA

(76) Inventors: Mark Watabe, Cambridge, MA (US); Dan M. Worrall, JR., Golden, CO (US)

Correspondence Address: Dan Worrall Jr., 1908 East St, Golden, CO, 80401, US

(21) Appl. No.: 12/506,252

(22) Filed: Jul. 21, 2009

Related U.S. Application Data
(60) Provisional application No. 61/096,772, filed on Sep. 13, 2008.

(51) Int. Cl. G06F 3/048; G06F 3/01; G06Q 10/00; G06Q 50/00; G06Q 30/00

(52) U.S. Cl. 715/760; 715/853; 715/828; 705/5; 705/80

(57) ABSTRACT

A method for organizing data according to a time based parameter displayed on a linear axis includes providing a visual user interface. The interface has a first area and a second area. The first area is larger than the second area. The second area has at least one bar extending horizontally and illustrates a time-line wherein earlier times are farther to the left and later times are farther to the right. The image illustrated in the first area is determined based on selection by the user of a portion of the various times illustrated in the bar in the second area.

### RELATED APPLICATIONS

This application claims benefit to U.S. Provisional Application No. 61/096,772 that was filed on Sep. 13, 2008, the entirety of which is incorporated herein by reference.

### TECHNICAL FIELD

The present application generally relates to personal organization programs and associated user interfaces associated therewith. The computer programs at issue can be associated with a personal computer as well as other personal electronic devices such as personal data assistants (PDA's), I-phones, laptop style computers, i-phones, and other capable electronic devices.

### BACKGROUND

Tools for displaying and organizing a person's time and managing projects are desirable. For example, an electronic daily planner allows the person to make notes of future events and appointments, and programs such as MS Project allow detailed long term scheduling.

### SUMMARY

An embodiment can include a computer system comprising a physical user interface; a visual user interface having a first area and a second area; the second area comprises at least two sequential time bars extending from left to right on the visual user interface, the bars representing a progression of time wherein an earlier time is farther to the left and a later time is farther to the right; the first area illustrating a portion of time determined by a selection from the at least two sequential time bars.

### BRIEF DESCRIPTION OF THE DRAWINGS

FIG. 1 is a screen image of an interface, shown at the minute zoom level.

FIG. 2 is a screen image of an interface, shown at the hour zoom level.

FIG. 3 is a screen image of an interface, shown at the day zoom level.

FIG. 4 is a screen image of an interface, shown at the week zoom level.

FIG. 5 is a screen image of an interface, shown at the month zoom level.

FIG. 6 is a screen image of an interface, shown at the year level.

FIG. 7 is a screen image of an interface at the decade level.

FIG. 8 is a screen image of an interface at the century level. The interface is populated with genealogical data of a user.

FIG. 9 is a screen image of an interface at the month level. The right click selection menu, when a user right clicks in a period of the interface in the past, relative to “now”.

FIG. 10 is a screen image of an interface at the month level. The right click selection menu is displayed on the screen when a user right clicks in a period of the interface in the future, relative to “now”.

FIG. 11 is a screen image of an interface at the day zoom level with the create event menu displayed on the interface.

FIG. 12 is a screen image of an interface at the day zoom level with the select event end option after an event is created.

FIG. 13 is a screen image of an interface at the day zoom level. The detailed event creation menu is displayed on the interface.

FIG. 14 is a screen image of an interface at the day zoom level displaying the event after it is created.

FIG. 15 is a screen image of an interface at the millennium zoom level. Global temperature data is displayed on the interface.

FIG. 16 is a screen image of an interface at the day zoom level showing the to do list in its latent state.

FIG. 17 is a screen image of an interface. The To Do list, when opened by a user, is displayed on the interface.

FIG. 18 is a screen image of an interface at the day level displaying the create To Do list menu.

FIG. 19 is a screen image of an interface at the day zoom level. The view standard monthly calendar option is shown.

FIG. 20 is a screen image of an interface at the day zoom level, displaying weather data at a user's location and at time.

FIG. 21 is a screen image of an interface at the day zoom level. Incoming emails are displayed on a user's interface at the time they are received.

FIG. 22 is a screen image of an interface at the day zoom level. A users personal financial information is displayed on the interface.

FIG. 23 is a screen image of an interface at the day zoom level. A user's diet information is displayed on the interface.

FIG. 24 is a screen image of an interface at the hourly zoom level displaying movie times at a user's local theaters.

FIG. 25 is an example of an interface when visualized in 3D mode. The interface is shown at the hour level and an alarm is displayed on the interface.

FIG. 26 is an example of an interface when visualized in 3D mode at the hour zoom level with an upcoming event displayed.

FIG. 27 is an example of an interface when visualized in 3D mode at the week zoom level.

FIG. 28 is an example of an interface when visualized in 3D mode at the week zoom level with the smaller time lines faded out.

FIG. 29 is an example of an interface visualized in 3D mode at the decade zoom level. Historical data is displayed on the interface.

FIG. 30 is an example of the computer logic used to create the interface.

FIG. 31 is an example of a realization of one of the logic steps of FIG. 30 resulting in an example of an interface depicting the future.

FIG. 32 is an example of a realization of one of the logic steps of FIG. 30 resulting in an example of an interface depicting the past.

FIG. 33 is an example of a realization of one of the logic steps of FIG. 30 resulting in an example of an interface depicting the past, present, and future.

FIG. 34 is an example of a realization of one of the logic steps of FIG. 30 resulting in an example of an interface.

FIG. 35 is an example of a realization of one of the logic steps of FIG. 30 resulting in an example of an interface displaying an object, the duration and time of occurrence of said object determined by its relative position to the labeled time scale.

FIG. 36 is an example of a realization of one of the logic steps of FIG. 30 resulting in an example of an interface depicting an event tied to the interface by the time of the event and the time depicted by the interface.

FIG. 37 is an example of a realization of one of the logic steps of FIG. 30 resulting in an example of an interface depicting a stationary time set with a time object with duration and with the separation between past and future, or now, moving to the right as time passes.

FIG. 38 is an example of a realization of one of the logic steps of FIG. 30 resulting in an example of an interface depicting the present in a stationary manner, whereby time objects move relative to a user as time advances.

FIG. 39 is an example of a realization of one of the logic steps of FIG. 30 resulting in an example of an interface whereby a user selecting to display now centers the present time on a display and displays time objects relative to the present time.

FIG. 40 is an example of a suitable operating environment of an embodiment.

### DETAILED DESCRIPTION

Preferred embodiments are now described with reference to the drawings, wherein like reference numerals are used to refer to like elements throughout. In the following description, for purposes of explanation, numerous specific details are set forth in order to provide a thorough understanding of the subject embodiments. It may be evident, however, that various embodiments may be practiced without these specific details. In other instances, well-known structures and devices are shown in block diagram in order to facilitate describing the embodiments.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable file, a thread of execution, a program, or a computer. By way of illustration, both an application running on a server and the server may be localized on one computer or distributed between two or more computers, and/or a thread of execution and a component may be localized on one computer or distributed between two or more computers.

The following presents a simplified summary of certain preferred embodiments in order to provide a basic understanding of the various embodiments. It is not meant or intended to unduly limit the scope of any present or future claims relating to this application.

According to an embodiment, a graphical user interface is visualized on a computer display. The graphical user interface comprises a time bar, a control bar and a zoom canvas. The graphical user interface represents time running left to right, from an earlier point in time to a later point in time. This time period can be in the past, the future, or a combination of the two. The time bar graphically designates the time visualized on the computer display by the graphical user interface. Additionally the time bar designates discrete units of time (e.g., minutes, hours, days etc.) within the zoom canvas. The control bar may include various icons that enable or disable various actions and visualization on the zoom canvas. The rest of the display, referred to hereafter as the zoom canvas, is used to display objects selected by a user or the graphical user interface.

Objects used in computing can have annotated metadata that includes time information. Annotated time information can be, but is not limited to, metadata established at the object's creation, time data input by a user, or time data from an external source. Objects are then displayed on the graphical user interface such that their annotated time data aligns the object with the time displayed by the time bar. For instance, in various embodiments, if an alarm is set at a given time the alarm will be visualized on the display such that the annotated time information for the alarm is aligned with the corresponding discrete time denoted by the time bar. Objects can include, for example, alarms, schedule items, meetings, project timelines, birthdays, anniversaries, pictures, URLs, documents, news stories, sporting events, movie times, weather forecasts, financial information, diet and food consumption information, and/or exercise data, in any desired combination.

Navigation through the time represented on the graphical user interface can be seamlessly performed through the time bar. By selecting an element from the time bar, a user can snap zoom to the selected time interval on the zoom canvas. Snap zoom refers to the process whereby the selected specific quantity of time is fitted to the display. For instance, selecting “June 10”, will fit and center June 10 on the zoom canvas and the graphical user interface will only display objects with time data relevant to this time interval. Selecting “June” will perform the aforementioned actions for the time interval of the month of June. All aspects of a given date will be available to snap zoom to via the time bar. As an example, if the graphical user interface displayed Jun. 20, 2008, a user could zoom to Jun. 20, 2008 in its entirety, zoom to June 2008 in its entirety, or zoom directly to 2008 in its entirety. There are many other methods of navigating through the graphical user interface, and snap zoom through selection of discrete time intervals is described as but one example.

Furthermore, a user may have full control over all objects displayed on the graphical user interface. This includes object creation, deletion, and modification. The objects displayed can be selectable via selecting an icon on the control bar, or other methods of selection, and then visualized on the display. Filter parameters can include the contents of a virtual folder, related project files, image files, news items, weather information and many other categorizations of objects. Furthermore, objects may be fully searchable from the graphical user interface.

By displaying a larger number of the important life information of a user in one graphical user interface, it can be expected that the user will spend a greater percentage of their computing time interacting with the interface. For this reason, and for the innovative display of time this application puts forward, there are many new click-through advertising possibilities. The graphical user interface of this application would allow time-targeted advertising. If a user were to search for movie tickets, the different results would be visualized on the zoom canvas with their appropriate start times. The user would then select a showing and be directed to a ticket purchasing site. This method could be used for, but not limited to, concert tickets, sporting event tickets, hotel rooms, car rentals or vacation rentals.

Additionally, the application may have a 3-dimensional (3D) view mode. In 3D view, the time bar may indicate time running from left to right. The immediate front of the screen may visualize time demarcated by the time bar. The time intervals indicated by the time bar may start to coalesce into a vanishing point at a specified depth in the axis perpendicular to the display. Therefore, at points visualized as deeper in the display, the graphical user interface may be able to visualize greater periods of time for the time indicated by the time bar.

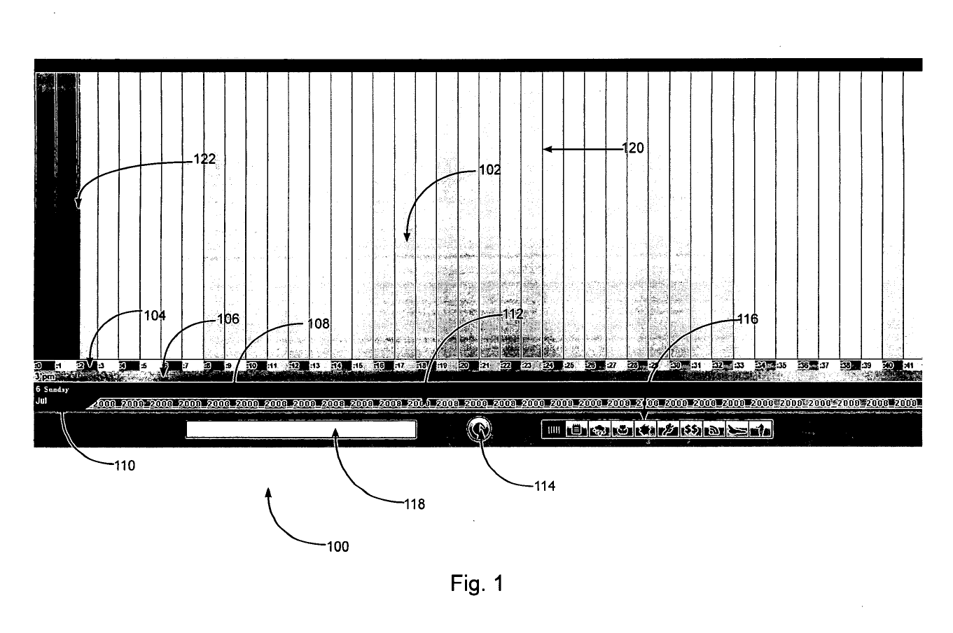

In general, an aspect of the present application is directed to a computer-implemented method for visualizing items on a graphical user interface (GUI). FIG. 1 is an embodiment of a visualized GUI. Item 100 is an instance of the GUI under certain parameters, with time depicted as running left to right, a time point on the GUI to the left occurring before a time point on the right. The Zoom canvas 102, is the space of the screen a user may display his or her time-based data on. Points on the zoom canvas 102 correspond to a time denoted by the time bar, 104-112. Item 112 is the year bar component of the time bar. All points above the individual dates denoted in the year bar 112 are defined as existing in the year indicated by the year bar 112. The year bar 112 displays “2008” across the full width of the display. Thus, all elements displayed on the zoom canvas 102 exist in the year 2008. Element 106 is the hour bar, indicating the hour values of objects visualized in the zoom canvas in the same method the year bar 112 does for year values. Element 108 is the day bar, indicating the day values of objects visualized in the zoom canvas 102 in the same method the year bar 112 does for year values. Element 110 is the month bar, indicating the month values of objects visualized in the zoom canvas in the same method the year bar 112 does for year values. The month bar, in this case, is visualized in such a manner that its color is indicative of which day values belong to a particular month. In this case, the month July is displayed in the month bar 110 and is displayed green. As the day bar 108 is displayed green, the GUI indicates to the user that the time they are viewing is in Jun. 6, 2008. Element 104 is the day bar, indicating the day values of objects visualized in the zoom canvas in the same method the year bar 112 does for year values. In this case, the time at the left of the screen is 3:00 pm, Jul. 6, 2008. The time at the right of the screen is 3:41 pm, Jul. 6, 2008.

“NOW”, i.e., the current time to a user, is indicated by 122. Time that is shaded, to the left of 122, is in the past; time that is not shaded is in the future with respect to the user's current time. In this case, 122, indicates that “NOW” for this user is at 3:02 pm, Jul. 6, 2008 based on the readings from the time bar, 104-112.

The tick marks 120 are an aid for a user to more easily discern what time value a location on the zoom canvas 102 has. In various embodiments, the design may calculate the intervals of time most useful to a user to display on the zoom canvas 102. In this case, the GUI displays a tick mark at every minute.

There are two modes of time movement in this embodiment. The first is that the time at the left edge of the display and the right edge of the display are fixed. In this case, NOW's location moves relative to the display, so the boundary indicated by 122 would move from left to right on the display. In this mode the time bar is stationary. The second mode of time movement is that NOW is centered on a user's display and the time indicated on the display moves from right to left. In this mode, the screen will always have NOW at center, or some other fixed point on the screen. The time on the zoom canvas 102, any events displayed on the zoom canvas 102, and the time indicated by the time bar move with respect to NOW. The “NOW” button 114, when selected by a user, sets the boundary of past and present, 122, to the center of the display (or some other point) and sets the GUI to the second mode, with NOW stationary and the time bar moving from right to left.

Preferably, a user will be able to select different periods of time at different zoom levels to visualize on the display by selecting items in the time bar 104-112. This process is referred to herein as “snap zoom.” Each time scale visualized on the time bar at one time is selectable. Upon selection, the selected time interval at the selected date will zoom such that the selected time interval fills the entire display area. For instance, by selecting July in the month bar 110, the zoom canvas 102 will snap to display all of July and all of the user's data with corresponding metadata linking it to July. Likewise, selecting the minute bar 104 at the 3:10 minute mark will fill the display with the data associated with 3:10 pm, Jul. 6, 2008.

Item 116 is a control bar with icons that allow a user to select different data sets to display on the zoom canvas 102. For instance, by selecting the news icon 124, news articles would display on the zoom canvas 102 with the news articles aligned with the time bar 104-112 with respect to the time metadata attached to the news article. Other examples of items in the control bar 116 include, but are not limited to, the financial icon 126, the exercise icon 128, and the weather icon 130. These function in a similar manner to the news icon 124.

Item 118 is the Search bar. A user can search their data via a keyword entered in the Search bar 118 and zoom to the time frame associated with the data's metadata.

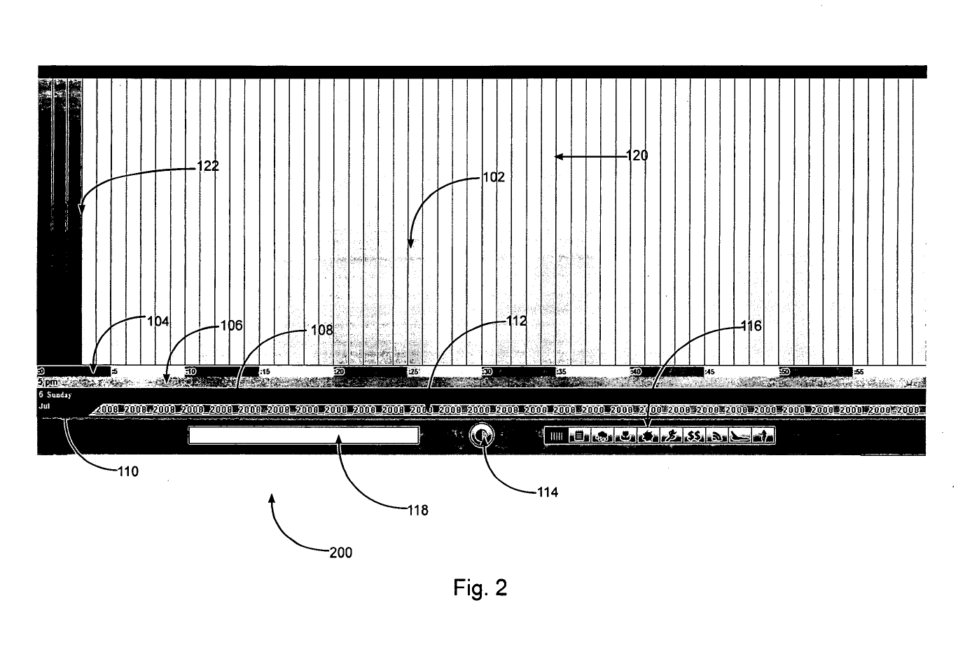

FIG. 2 and item 200 show the same embodiment as FIG. 1 but at a further out zoom level. FIG. 2 demonstrates the action taken by this embodiment after a user selects “5 pm” from the hour bar 106. The hour of 5 pm is stretched across the zoom canvas 102 to fill the display area. As the time bar zooms out, this embodiment filters out unnecessary or overly detailed information to make the zoom canvas 102 easier to understand for a user. In this instance, the minute bar 104 is now only showing five-minute intervals instead of an interval every minute. In addition, a user will only be able to snap zoom to the interval visualized on the display. In this case, the smallest interval a user will be able to select is a 5-minute interval on the minute bar 104. In FIG. 2, the NOW boundary 122 is at 5:03 pm, Jul. 6, 2008, indicating that at the moment this screen shot was taken, the user's current time was 5:03 pm, Jul. 6, 2008.

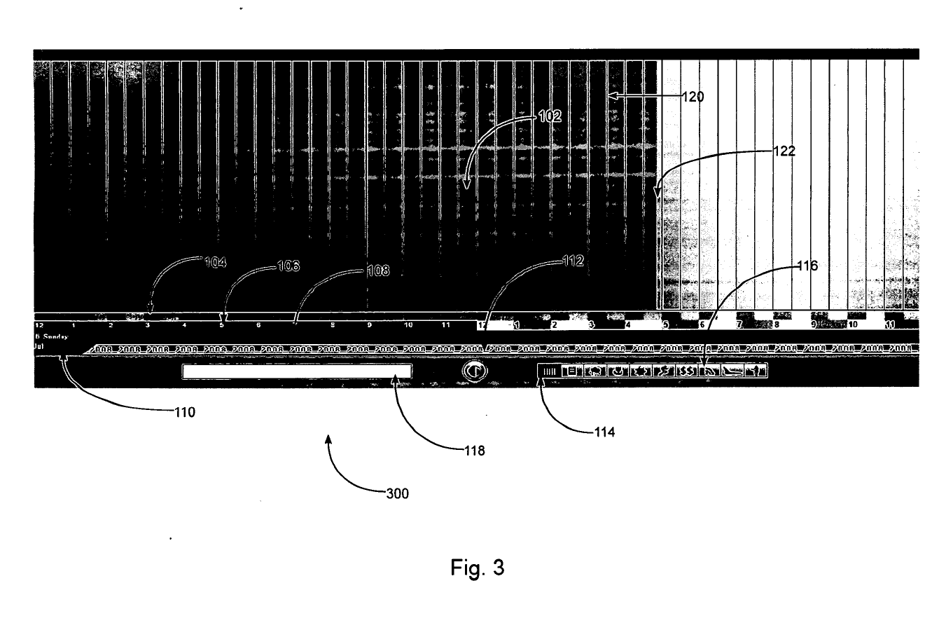

FIG. 3 and item 300 show the same embodiment as FIGS. 1 and 2 but at a still further out zoom level. Item 300 displays the interface after a user selects July 6 from the day bar 108. The full 24-hour period of Jul. 6, 2008 has been visualized on the display. The zoom canvas 102 now represents from 12:00 am, Jul. 6, 2008 to 11:59 pm, Jul. 6, 2008. In this case, the “NOW” boundary 122 represents the time at approximately 4:50 pm, Jul. 6, 2008. Note that the minute bar 104 has been reduced further so that only 30-minute intervals are visualized and are selectable. The tick marks, 120, are displayed at these 30-minute intervals.

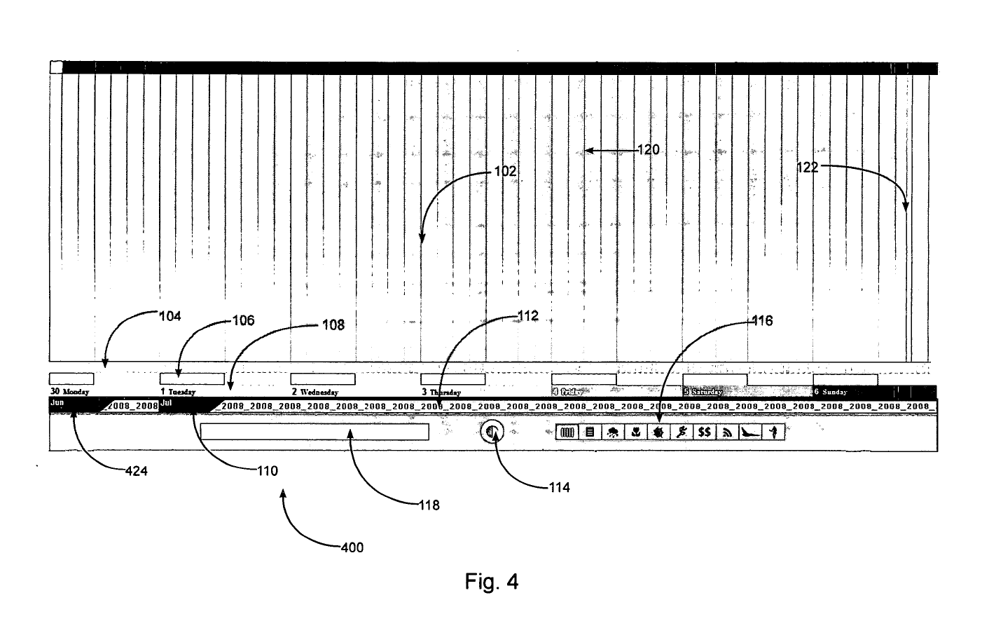

FIG. 4 and item 400 displays the same embodiment as the preceding figures but with the zoom canvas 102 zoomed out to display one full week. On this slide, the minute bar 104 still displays 30-minute intervals. The hour bar 106 is displaying 12-hour intervals. In addition there is more than one month on display. Item 424 is an element of the month bar 110 and indicates the month of June. The area of the zoom canvas 102 above item 424 is in June, while the area of the zoom canvas 102 visualized above 110 is in July. The tick marks 120 indicate 4-hour intervals on the zoom canvas 102. The “NOW” boundary 122 indicates 5:00 pm, Jul. 6, 2008.

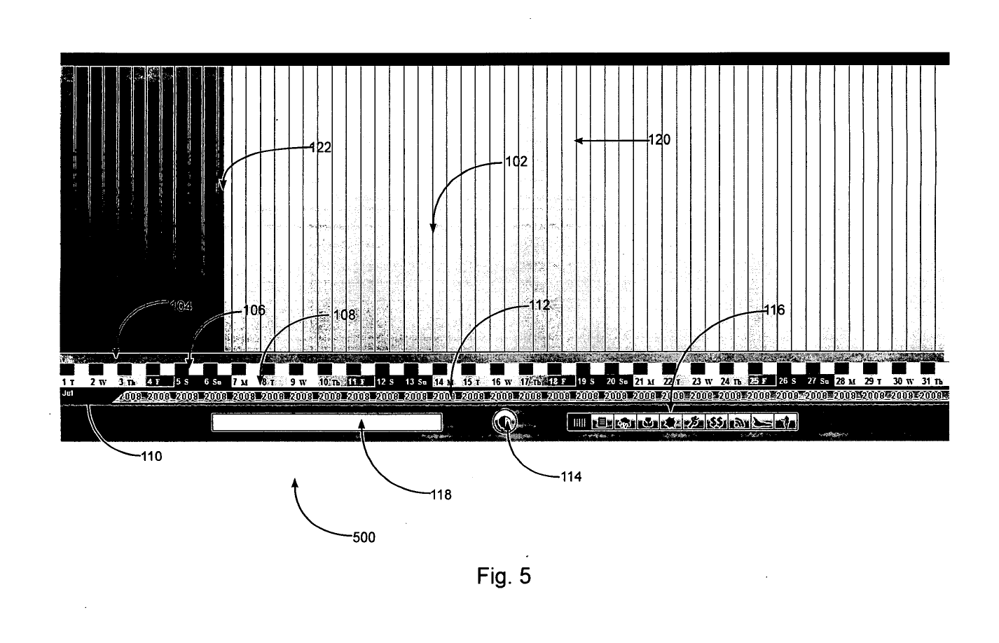

FIG. 5 and item 500 display this embodiment when zoomed out to display a full month of time on the zoom canvas 102 and the time bar 104-112. In this case, a user has selected July from the month bar 110. This embodiment has shifted and zoomed the zoom canvas 102 so that the beginning of July is aligned with the left side of the display and the end of July is aligned with the right side of the display. In FIG. 5, the “NOW” boundary represents 5:00 pm, Jul. 6, 2008. The color gradient of the day bar 108 indicates what day of the week that date is. The gradient progressively darkens from light hue on Monday to a dark hue on Sunday. In FIG. 5 the tick marks 120 are visualized at 12-hour intervals.

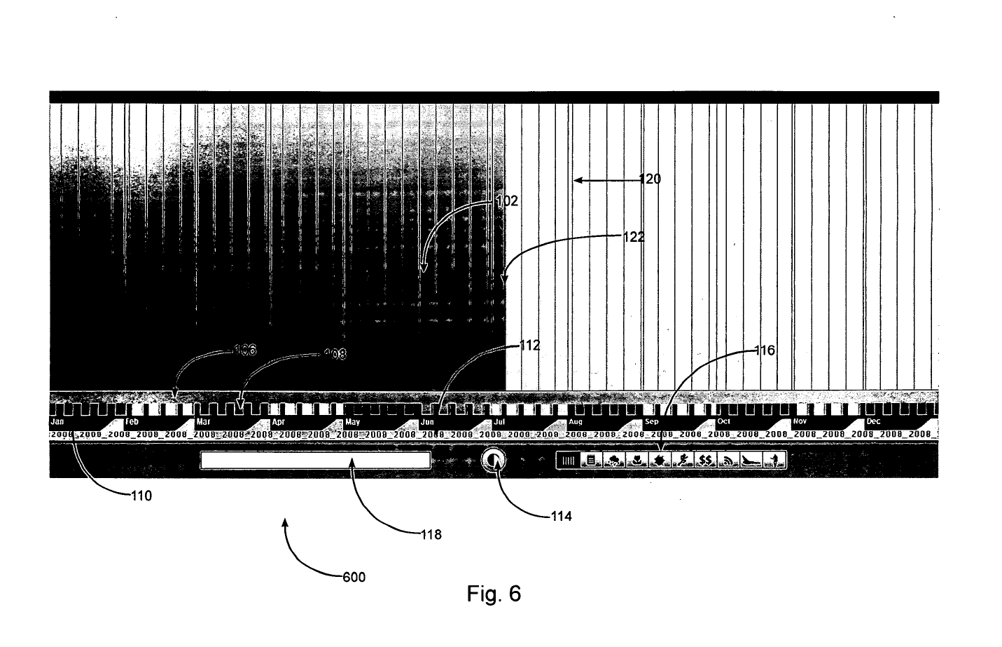

FIG. 6 and item 600 are a visualization of this embodiment at the one year scale. If a user selected any section of the 2008 section of the year bar 112, in this case the entire year bar represented 2008, the embodiment will visualize on a display all of 2008 on the zoom canvas 102. The twelve months of the year are now visualized on the month bar 108 and the zoom canvas 102. The “NOW” boundary 122 indicates 5:00 pm, Jul. 6, 2008, although the hour distinction at this zoom level is difficult for a user to distinguish. The minute bar 104 has been covered as the month bar 110, day bar 108, and hour bar 106 have shifted upwards in the time bar space 104-112. This is because at this zoom level, a user would not find hour-based data useful or visually appealing. In FIG. 6 the “NOW” boundary 122 is still at 5:00 pm, Jul. 6, 2008. The tick marks 120 display every Sunday, and at the end of every month.

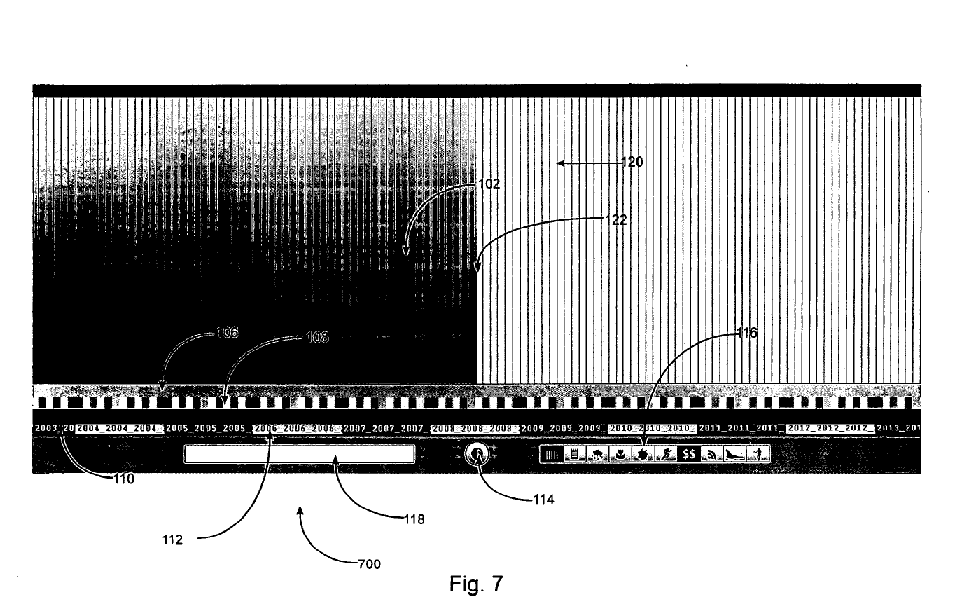

FIG. 7 and item 700 are a screen shot of an embodiment when shown at an extended zoom. In this case the zoom canvas 102 and the time bar 104-112, visualize a period of 10 years on the display. The month bar 110 may display each quarter of each year by color, and the day bar 108 may indicate the individual months by date. The “NOW” boundary, 122, is at 5:00 pm, Jul. 6, 2008. The “NOW” button, 114, has been selected by a user, centering NOW at the center of the screen and causing it to switch into the time movement mode whereby the zoom canvas 102 and time bar 104-112, move relative to NOW and the display screen's boundaries.

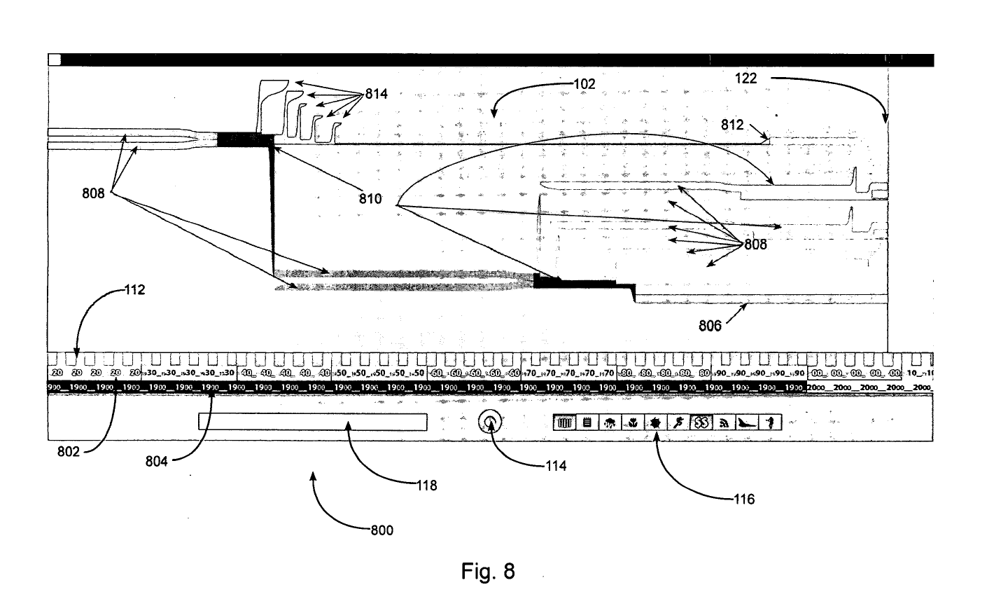

FIG. 8 and item 800 again display an embodiment, in this case displaying a full century on the zoom canvas, 102 and time bar, in this case 112, 802-804. As the user has zoomed out, the year bar 112 has moved up in the time bar and the decade bar 802 and century bar 804 have been visualized in the time bar portion of the display. Both the decade bar and century bar are capable of being selected by a user and thereby “snap zoomed” to fill the display. The “NOW” boundary 122 is still located at 5:00 pm, Jul. 6, 2008. The left side of the display is aligned with the year 1923 and the right side aligned with the year 2013.

FIG. 8 also displays a particular data set belonging to a particular user for the first time. The data in this instance is genealogical data. Item 806 indicates the user's current life span, with life bar beginning with the user's birth in 1982 and ending at the “NOW” boundary. Items 808 are indicators of other life bars within the user's family. Blue colored bars represent male life bars, red colored bars represent female life bars. Items 810 depict marriages, and visualize two life bars 808, coming together to form the marriage bar 810. When a couple has children, the marriage bar expands to show the creation of a new life bar 808 for the new child. Just as in life bars, the beginning and end of a marriage are indicated by their position on the zoom canvas 102 and the time described by the time bar 104, 802, 804. Item 812 indicates the death of one member of a marriage in 1996. The male life bar reemerges until the male life bar ends in the year 2005. The Items 814 are the user's aunts and uncles from the user's father's side. The relative size of items 814 indicate the number of children each sub family had.

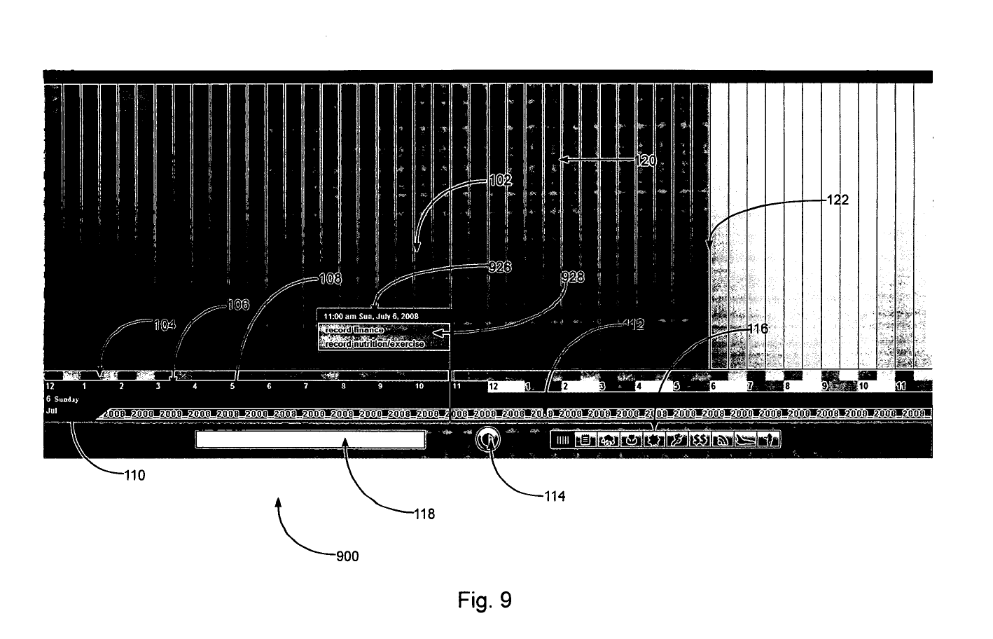

FIG. 9 and item 900 visualizes an embodiment of the interface at a zoom level that visualizes a full 24-hour day on the zoom canvas 102. The “NOW” boundary 122 is at 5:55 pm, Jul. 6, 2008. This Figure shows a create event menu 926 visualized on the interface. A user can access the create event menu through an input to this embodiment. This input can be, but is not limited to, a click input from a mouse or other physical interface device, e.g., a mouse or mouse pad on a lap top computer. FIG. 9 illustrates the “past” event creation menu 926 that is brought to view when the user inputs the event creation command (e.g., right click input) on a section of the zoom canvas 102 that is in the past relative to a user's current time, indicated by the “NOW” boundary 122. Item 128 is the list of options that the past create event menu 926 contains. In this case 128 visualizes the list items “record finance” and “record nutrition/exercise”. These are only examples of items a user can select in the past menu; the preferred embodiments are not limited to these options.

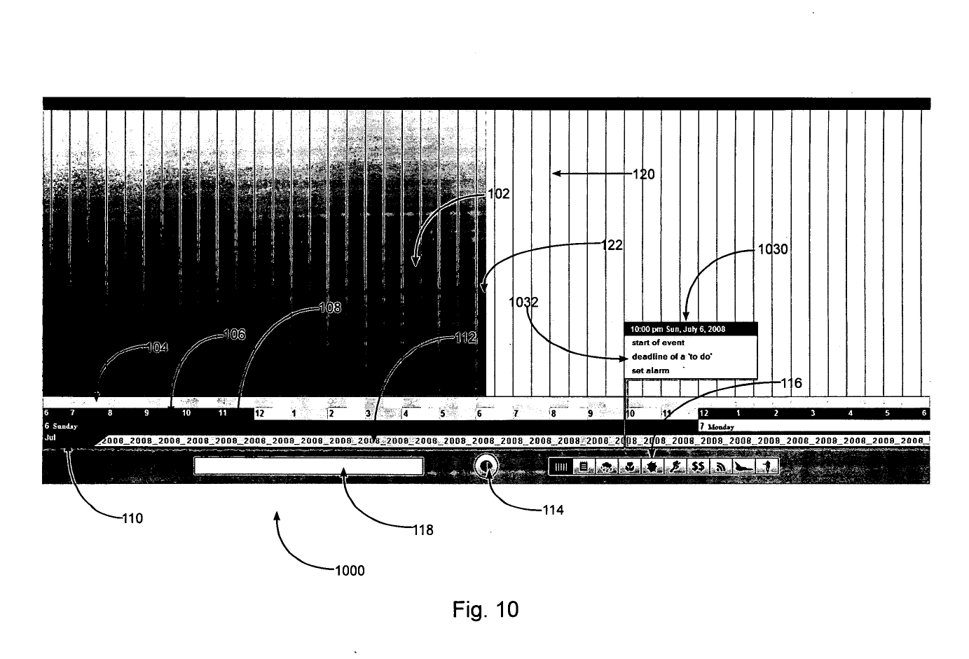

FIG. 10 and item 1000 visualize an embodiment displaying twenty four hours on the zoom canvas 102. A user has selected the “NOW” button 114 and the zoom canvas 102 and time bar 104-112 are positioned such that the user's current time, indicated by the “NOW” boundary 122, is centered on the display screen. In FIG. 10, a user has entered the “create event” input, in this case a right click in the future time area of the zoom canvas 102, or the area of the zoom canvas to the right of the “NOW” boundary 122. The “future” create event menu 1030 is displayed on the interface with the “pole” of the event creation menu aligned with the time on the time bar 104-112, indicated by the user based on the location of the user's cursor on the zoom canvas 102. The text on the future event menu 1030 indicates the exact time the event that will be created on through the event creation menu. In FIG. 10, the event creation menu 1030 indicates that the event created by the user will begin at 10:00 pm, Sunday, Jul. 6, 2008. Item 1032 is a list of options presented to a user on the future create event menu 1030. In this case the list options are, but are not limited to, “start of event”, “deadline of a ‘to do’”, and “set alarm”.

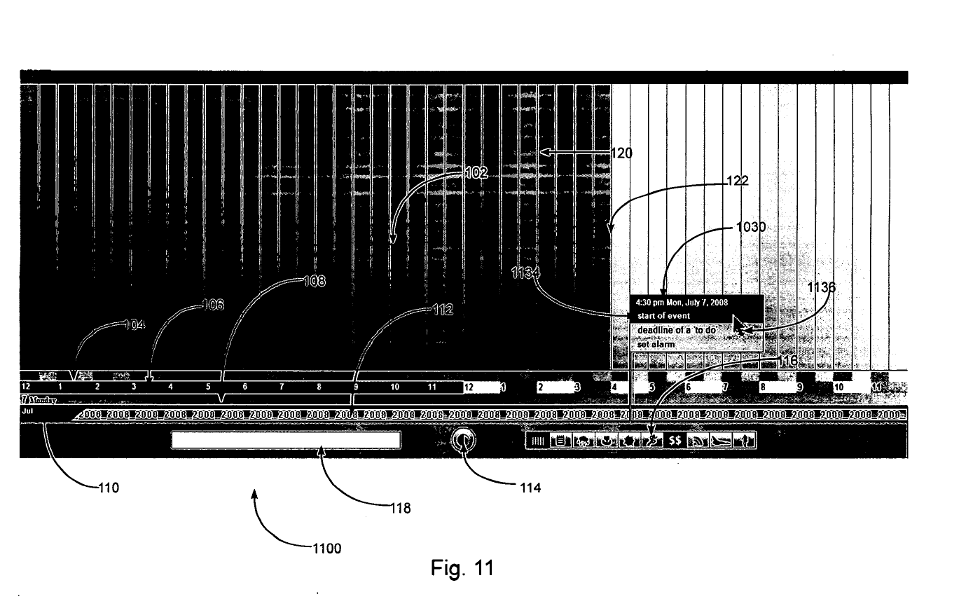

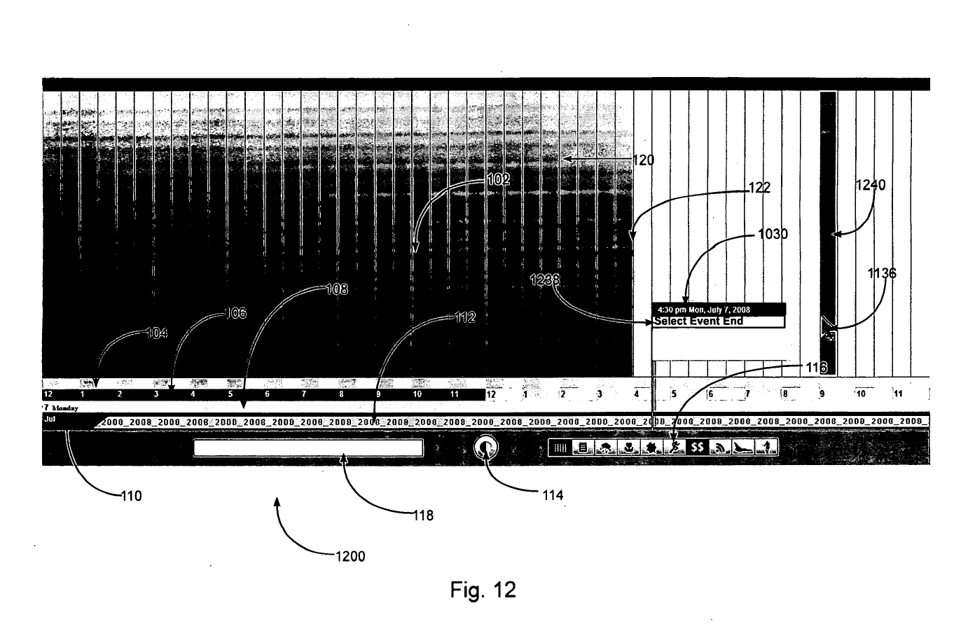

FIGS. 11-14 demonstrate the steps a user will take through this embodiment to create a new event. An event would commonly represent, but is not limited to, a business meeting, a party, a planned dinner, a movie, and a project date. In FIG. 11 a user has entered the future create event menu 1030 and this input occurred at the point of the zoom canvas 102 and time bar 104-112 that indicates 4:30 pm, Monday, Jul. 7, 2008. The user has selected “start of event” 1134, from the create event menu 1030 with cursor 1136. FIG. 12 visualizes the next step in event creation. The create event menu 1030 is still anchored at, and indicates the event will begin at, 4:30 pm, Monday, Jul. 7, 2008. Item 1238 indicates to the user the next expected input, in this case “Select Event End”. The user's cursor 1136 then is directed to, and the user selects, the desired time for the event to conclude. The end of event is highlighted by 1240, and is indicated as proceeding up to 9:30 pm, Monday, Jul. 7, 2008.

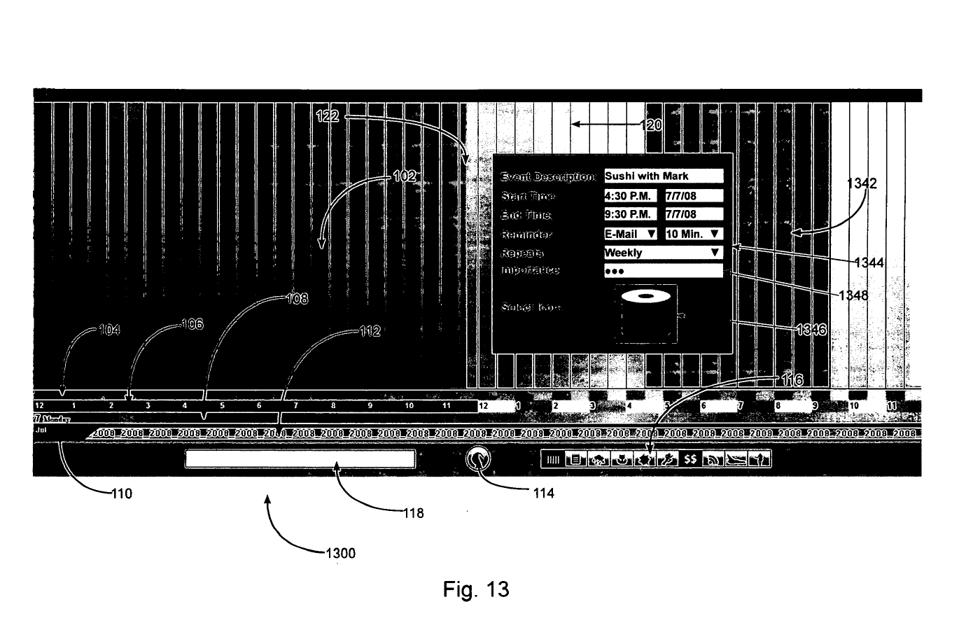

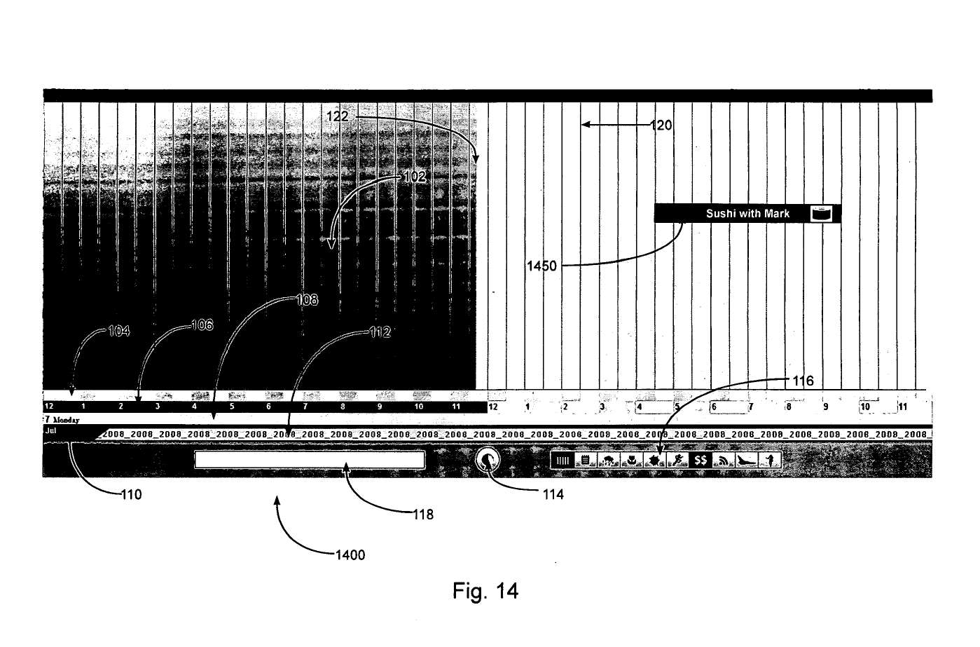

FIG. 13 visualizes the next step in event creation. The duration of the event in process of being created is highlighted 1342, on the zoom canvas 102. Item 1344 is the Event Description menu. A user can enter information regarding the event such as the “Event Description”, modify the exact start and end time of the event, select a form of reminder, such as an alarm or an email, and determine if the event will repeat on a regular basis. The Event Description menu 1344 may also include an Importance selector 1348, which will allow a user to determine the relative importance of the event. This will aid in resolving scheduling conflicts, and project management. The Event Description menu 1344 may also allow a user to select an icon 1346 to represent the event. The icon can be selected individually by the user, or by allowing this embodiment to automatically select the icon, by searching image databases by keyword from the event description and picking the icon from the image search results. For example, a user could create a dinner event. The system would search likely images, potentially select an image of a steak, and then use this image to represent the dinner event on the zoom canvas 102. FIG. 14 shows the results of the steps depicted in FIGS. 11-13. The created event 1450 is visualized on the zoom canvas 102, with the Event Description and Event Icon displayed. The created event 1450 aligns its start time, 4:30 pm, Monday, Jul. 7, 2008, with the area indicated by the time bar 104-112 as existing at 4:30 pm, Monday, Jul. 7, 2008. The end time of the created event 1450 9:30 pm, Monday, Jul. 7, 2008, is aligned with the area indicated by the time bar 104-112 as existing at 9:30 pm, Monday, Jul. 7, 2008.

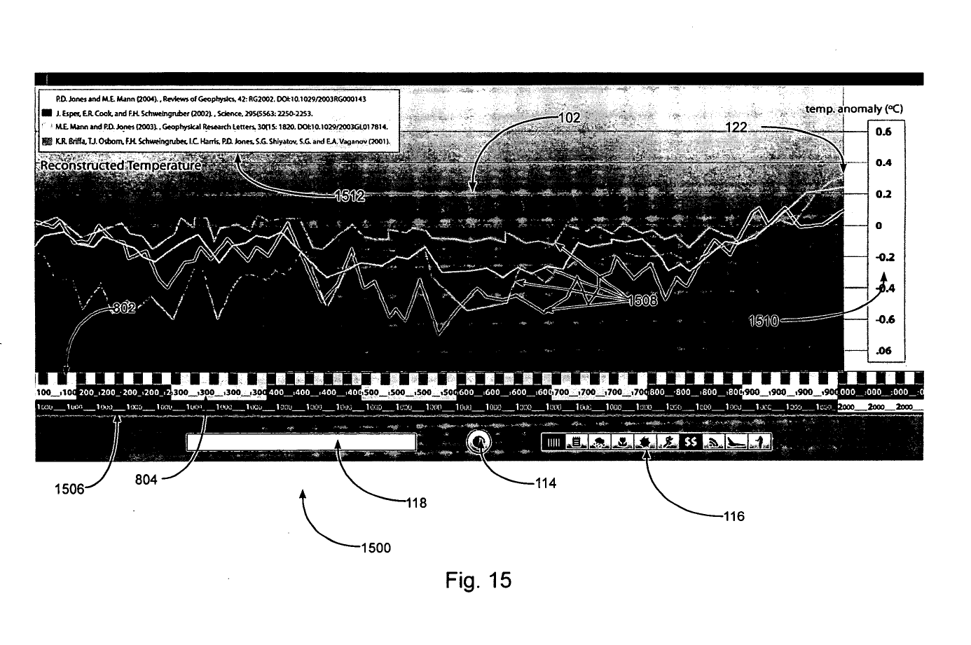

FIG. 15 and item 1500 are a screen shot of the visualization on a display by an embodiment, with the zoom set to display one thousand years. The time bar now is composed of the decade bar 802, the century bar 804, and the millennium bar 1506. A millennium indicated in the millennium bar 1506 labels any point in the zoom canvas 102 as existing within that millennium. In this case, the section of the zoom canvas 102 labeled by the millennium bar 1506 as 1000 indicates the dates between the years 1000 and 1999. The section of the zoom canvas labeled by the millennium bar 1506 as 2000 indicates dates between the years 2000 and 2999.

FIG. 15 further demonstrates an advantage of the depicted embodiment by displaying another form of data set on the same interface. In this case, global temperature data is displayed on the zoom canvas 102. The y axis of the zoom canvas 102 is labeled by item 1510, and is defined as the departure from average global temperature in degrees Celsius. Items 1508 are the temperature anomaly values in degrees Celsius for each date indicated by the time bar 802, 804 and 1506. Item 1512 is a label of the four different approximations visualized on the zoom canvas 102. FIG. 15 is used to demonstrate the ability of this embodiment to display any data set on the visualized user interface and the ability of various embodiments to display large time scales. The millennium zoom level is not necessarily the maximum amount of time this embodiment can visualize.

FIGS. 1-15 demonstrate the ability to visualize data on them minute, hour, day, week, month, year, decade, century and millennium level. These zoom levels were chosen to show the wide variety of time scales the design can visualize; however the zoom level is continuously variable. A user can zoom to any desired level (for example to view two hours, five days, etc.) by instructing the visualization mechanism to change. This is typically, but not limited to, done by adjusting the scroll wheel on a user's computer mouse.

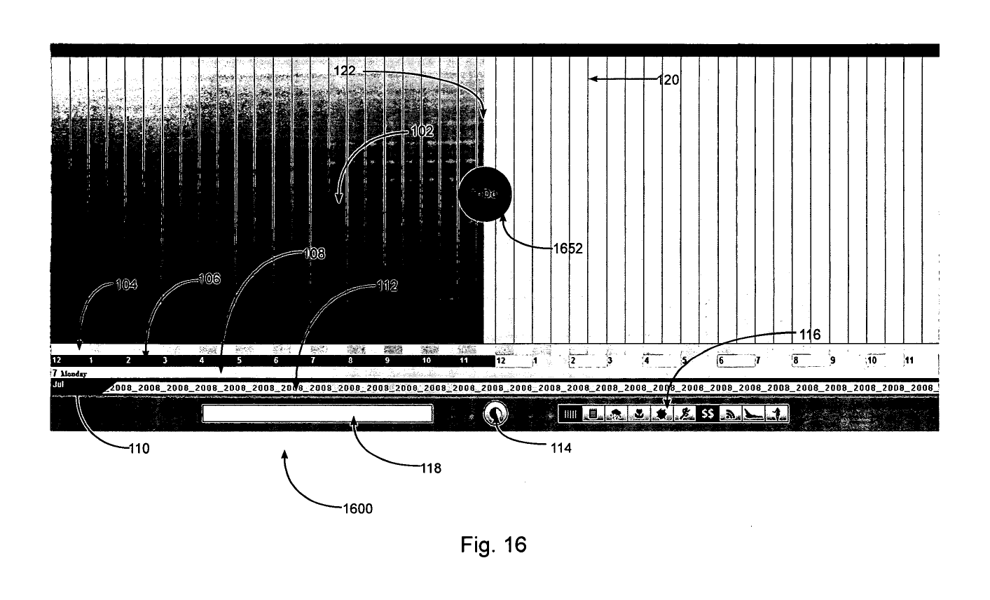

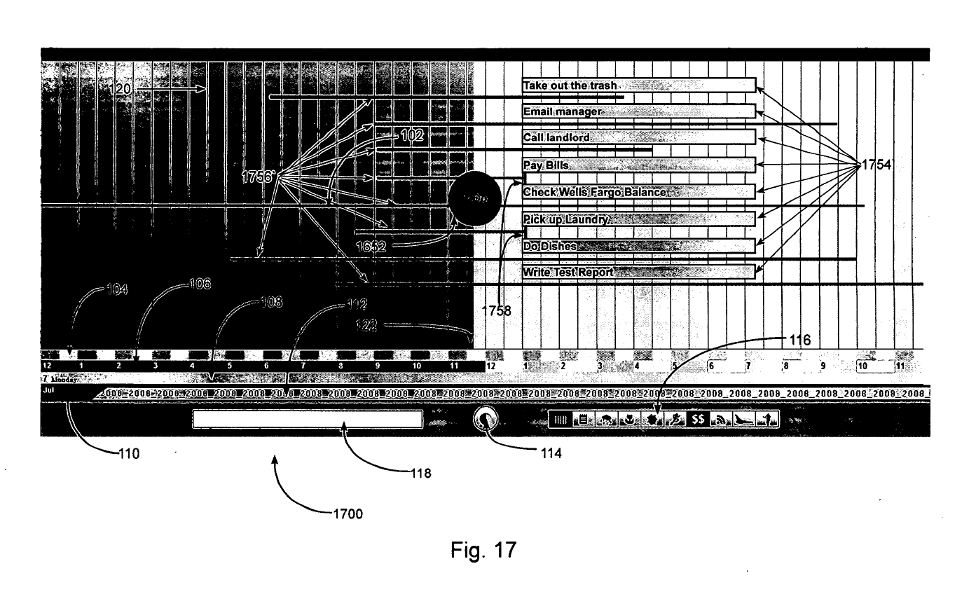

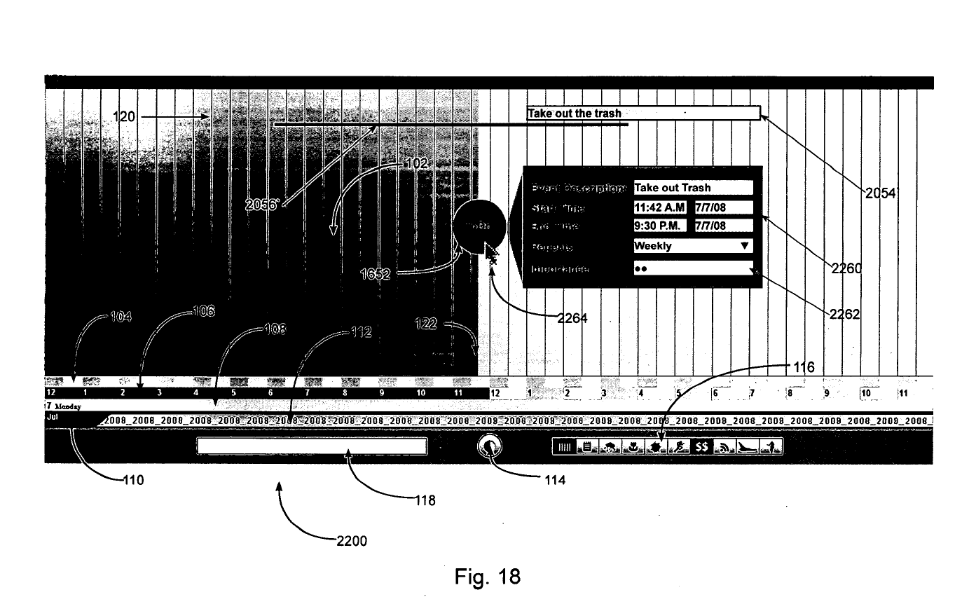

FIGS. 16-18 demonstrate the visualization, use, and manipulation of a To Do list within this embodiment and/or other embodiments. FIG. 16 displays the To DO list icon 1652 in the center of the screen. The To Do list icon is linked to the “NOW” boundary 122 to keep a user reminded of their current tasks or commitments. The To Do list icon 1652 is selectable by a user. FIG. 17 is a screen shot of the display after a user has selected the To Do list icon 1652. Items 1754 are items on the user's to do list and are visualized over the zoom canvas 102. Items 1756 are duration bars for each individual To DO list item. The duration bars 1756 may begin at the moment each To Do list item is created and end on the zoom canvas 102 at the point in time that the user selects as the To Do list item Due Date. Items 1758 indicate duration bars 1756, where the user did not define a Due Date for the To DO list item the duration bars are associated with. In the case of the To Do list items 1754, their location relative to the time bar is irrelevant, as the list items 1754 themselves do not have a begin and end time. This distinction is made so that the To Do list can be displayed as a list over the zoom canvas 102. The duration bars 1758 are tied to the time bar 104-112. The left hand side of a duration bar aligns with the time on the time bar at the point the duration bar was created. The right side of the duration bar aligns with the point on the time bar that indicates the time a user selects as the Due Date for an item on the To Do list. FIG. 18 is a screen shot visualizing the create To DO list item menu 1860. The create To Do list item menu 1860 may include, but is not limited to, input areas for a user to define a To Do list item's description, start time, due date (end time), its repetition interval, and its importance. Item 1862 is the importance selection bar. This allows a user to indicate the relative importance of a To Do list item. This embodiment will then display the user's To DO list items in order of importance. Item 1864 is the user's cursor. By default, Right Clicking (and other alternatives to “Right” clicking, e.g., “alt” clicking as in Mac operations, etc.) on the To Do List Icon 1652 will open the create To Do list item menu 1860. Items 1754 and 1756 indicate the To Do List item created by the Create To Do List menu visualized on FIG. 18.

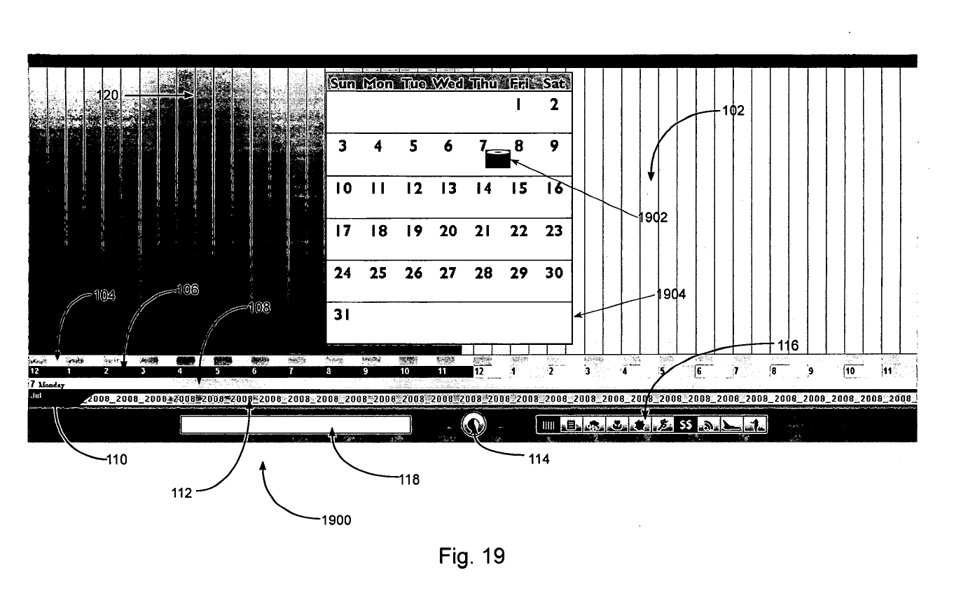

FIG. 19 and item 1900 are a screen shot of the embodiment in a calendar display mode. When selected, the calendar display mode may transfer a user's information in a standard monthly calendar view 1904. The data stored in association with this visualized display will be displayed as icons or text 1902 on the standard calendar view 1904.

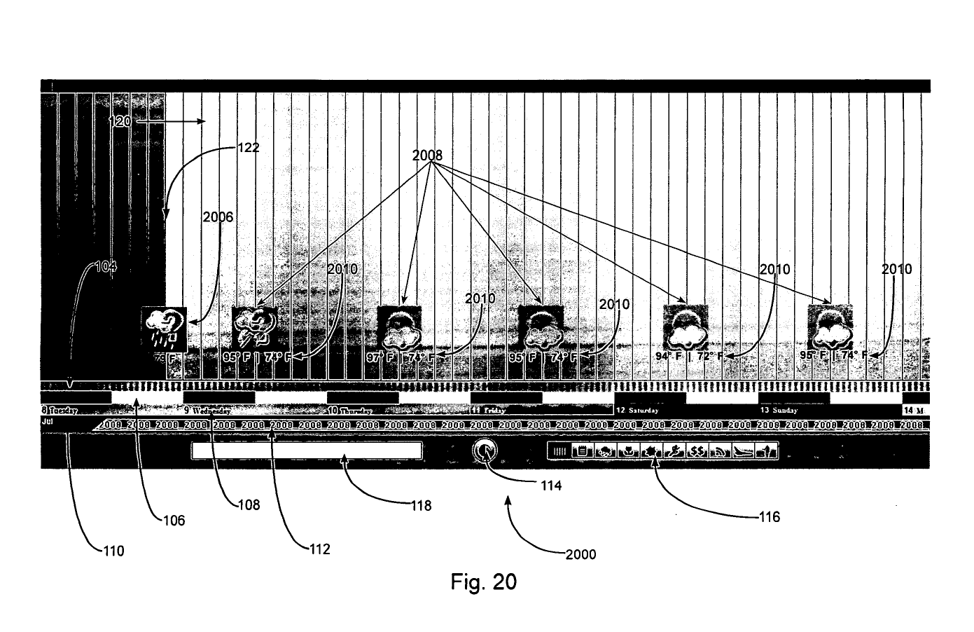

FIG. 20 and item 2000 are a screen shot possible in various embodiments. When instructed by a user, the embodiment will visualize the weather forecast for the user based on the user's zip code. The forecast information is readily available over the internet. Item 2006 is an icon depicting the current weather conditions for a user. Items 2008 are icons depicting the forecast for the next five days. Items 2010 are text items depicting the low and high temperature range for the day indicated by the time bar 104-112.

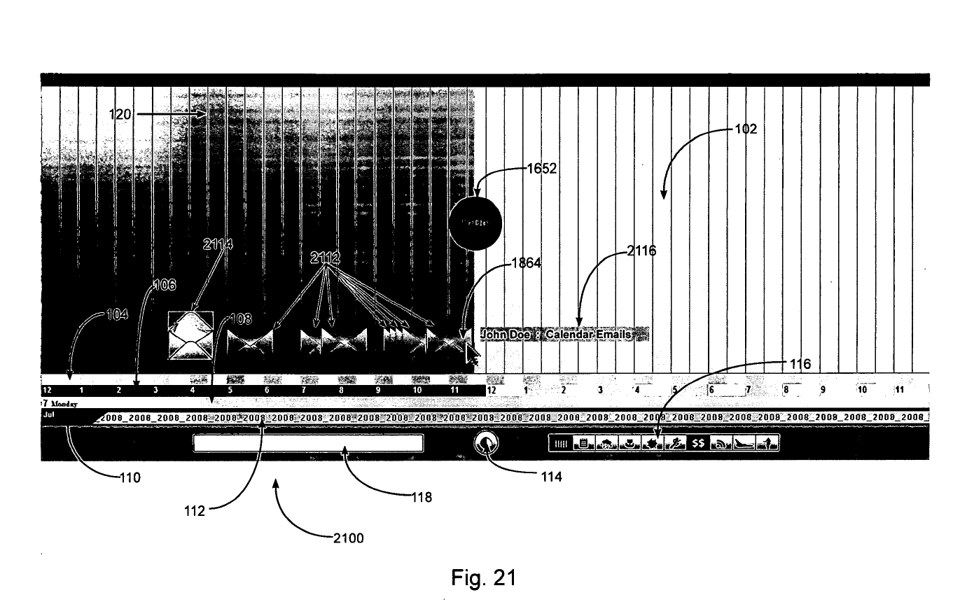

FIG. 21 and item 2100 are an embodiment visualizing the embodiment's interface displaying a user's emails on the zoom canvas 102. A user's emails may display on the zoom canvas 102, as email icons 2112, and will be aligned with the time bar 104-112, according to the time the email is received. If an email has been read by the user, the icon will change to display an opened letter 2114. If a user moves his or her cursor 1864 over an email icon 2112, various information about the email may display as a banner on the zoom canvas 102. This email banner 2116 may display information such as an email's “from” contact and/or the email's subject title.

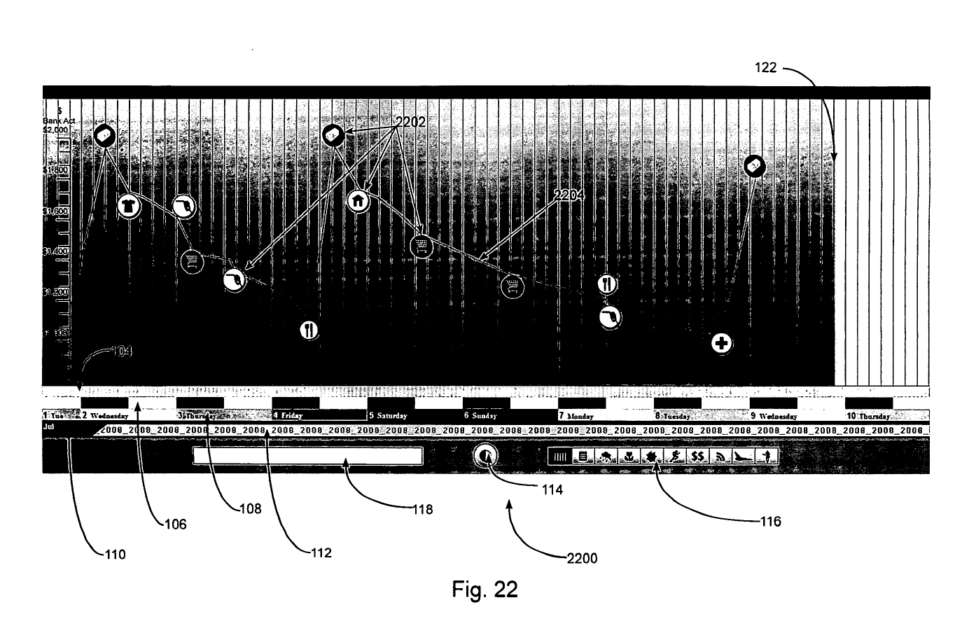

FIG. 22 and item 2200 are a screen shot visualizing an interface on a display. The zoom canvas 102, and the time bar 104-112, are displaying nine days. The interface in 2200 is displaying a user's financial data. In this case, the data indicates the user's bank account balance. Item 2204 is a line bar depicting the total funds in the user's bank account, defined by the legend on the left hand side of the zoom canvas 102. Items 2202 are icons depicting individual actions that affect the user's bank balance. For instance the time bar 104-112, indicates that on Jul. 4, 2008, the user had three actions that affected his or her bank account: a meal purchase that lowered the bank account, a deposit that raised the amount of money in the bank account, and a rent payment that lowered the bank account. The time of the zoom canvas 102 that represents actions occurring on Jul. 4, 2008 are indicated by the day bar 108 component of the time bar.

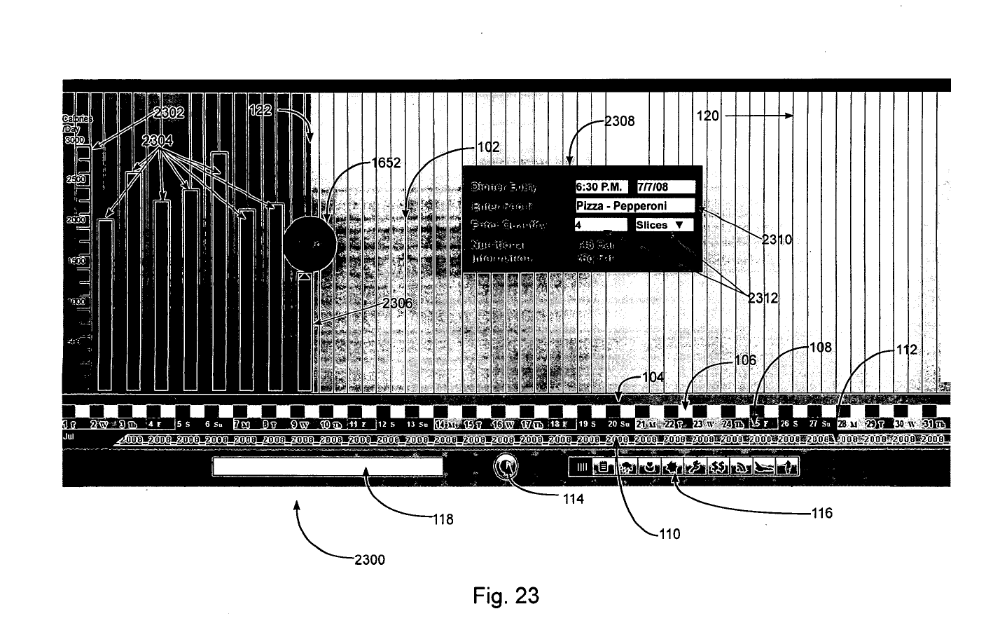

FIG. 23 and item 2300 are a screen shot visualizing an interface on a display and the one-month zoom level. Item 2300 indicates the visualization of the interface displaying a user's diet/food intake on the zoom canvas 102. Item 2302 is the Y-Axis label for the number of calories consumed by the user in each 24-hour period. Items 2304 indicate the daily caloric consumption of a user in a bar graph format. Each bar of items 2304 correspond to a day indicated by the time bar 104-112. The height of items 2304 indicate the total daily calories consumed by the user indicated by the axis label 2302. Item 2302 is the user's caloric consumption for the current day. Item 2308 is the input food consumption menu that allows a user to input any food intake they have. Item 2310 is the food entry bar. The food entry bar 2310 allows a user to select commonly eaten meals or to enter a new meal. Items 2312 allow the user to indicate the amount of a given food eaten at that meal. For common food items, the interface may provide options for the units of the amount eaten, for example ounces, half a pizza, or number of slices, and the nutritional information will then be calculated automatically. The nutritional information is a database that can be located on a user's local data storage or on an online network server. This embodiment can also display exercise data. In addition, a user can subscribe to a diet or exercise plan and see future meal and workout assignments in the future section of the zoom canvas 102.

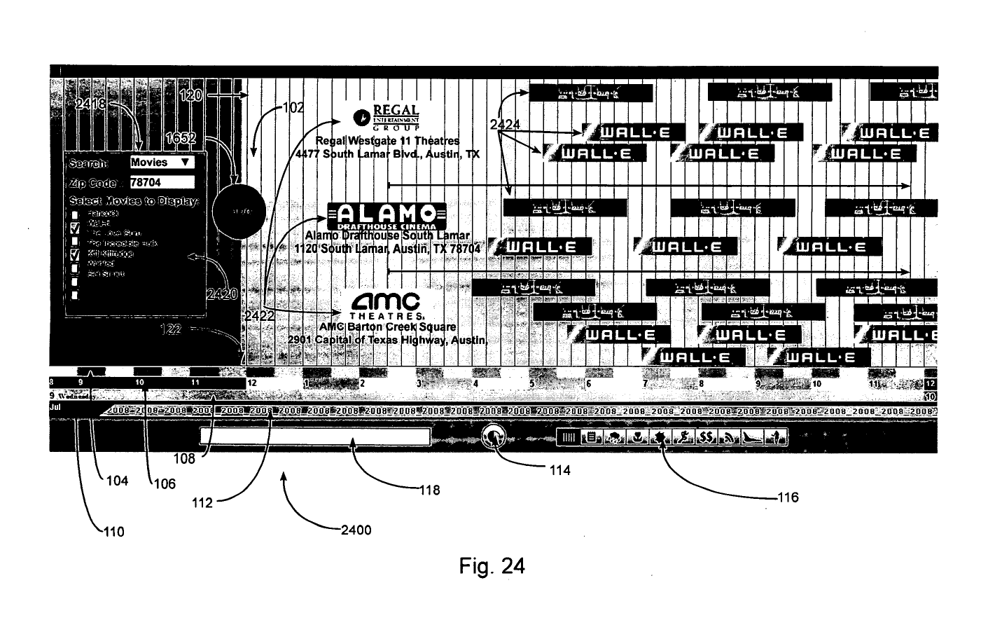

FIG. 24 and item 2400 are a visualization on a display of an interface displaying movie ticket purchase data and movie times. In item 2400, only movie times and ticket purchase information is displayed on the interface. The embodiment is capable of displaying and providing ticket times and purchase capability on the interface for any type of ticket: symphony, sporting events, pro wrestling, music concerts, festivals, movies, and conventions. When a user inputs an instruction to display ticket information, the ticket filter menu 2418 is visualized on the zoom canvas 102. The user may, for example, enter in their zip code (or the system may upload the zip code from memory or use a Global Positioning System “GPS” to determine a users location for example when a personal data device such as an I-phone or other smartphone is employing these embodiments), and select the type of ticket they wish to purchase. In this case Movie tickets are selected. Once a user selects the Movie ticket topic, this embodiment retrieves data on the movies that are currently playing, the movie theaters close to a user's zip code or other location information (e.g., a user may be able to create and store a list of favorite theaters), and the times each theater is playing each movie. The data is then visualized on the zoom canvas 102. Item 2420 is a list of movies showing in a user's nearby movie theaters. The user may select which movie's play times they wish to visualize on the zoom canvas on the movie list 2420. The movie theaters nearby the user's zip code, or selected based on other location indicating information, will be displayed on the zoom canvas as items 2422. In this example, all movie times to the right of a theater are considered to be playing at the theater indicated to their left. The movie times 2424 are displayed as bars with duration equal to the running time of the movie. The movie bars 2424 may be displayed with their start time and finish time aligned with the correct times on the time bar 104-112.

In various embodiments, a useful aspect of the movie bars 2424 is that they are selectable by a user in order to purchase a ticket. Selecting a movie bar directs a user to a website to purchase the ticket. Alternatively, various embodiments can allow a user to purchase movie tickets directly from the theaters. The zoom canvas 102 and movie bars 2424 may allow a user to view movie times (or any type of event times) in relation to other data a user has stored. This data of interest could include other events allowing the user to check for time and schedule conflicts, a user's financial data, enabling a user to check the availability of funds for ticket purchase, and/or the weather report for a user (which may be particularly useful for, e.g., deciding on purchasing tickets to an outdoor event). The interaction of advertising and ticket purchasing with time and a user's schedule are a particularly useful aspect of various embodiments. All of the information of the previous two paragraphs may also apply to any type of ticket purchasing data. The business method of selling tickets to time specific points of a user's personal time planner may be a particularly useful function of various embodiments.

Another, similar business method included in various embodiments is the ability for a user to designate time for vacation in their personal planner. Once this vacation time is established, the user may be allowed to seek bids from travel companies on this allotted time. This will allow travel companies to advertise directly to targeted, interested customers. This should allow users to receive low cost, discounted trips that already have been booked to the allotted vacation time period that a user has set aside.

A user can filter the information they wish displayed on the zoom canvas 102 by selecting the desired layers to display from the Control Bar 116. The default display may display a user's event data and any alarms the user has set. In addition, a user can access his or her To Do list by selecting the To Do list icon 1652. The user can access any other data set and instruct the system to visualize the selected data set on the zoom canvas 102 by selecting the appropriate icon on the Control Bar 116. The user can select any combination of data sets, such as the ones described previously in this application, or data sets such as a news feed. The system will format the zoom canvas 102 to display all the selected layers in a readable format.

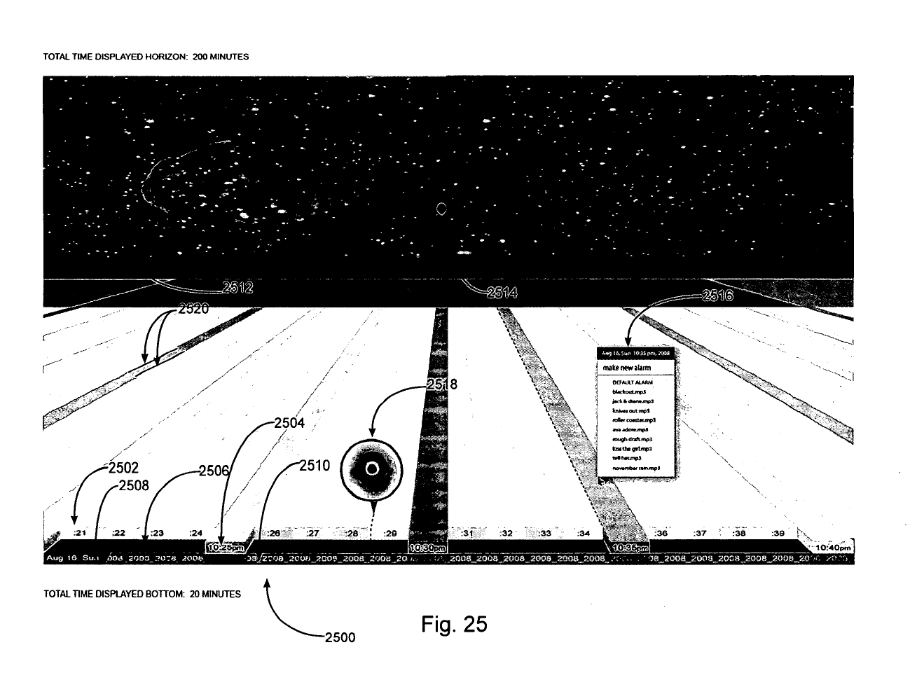

FIGS. 25-29 are visualizations of an embodiment in 3D mode. FIG. 25 and item 2500 are a visualization on a display of the embodiment in 3D mode. Item 2502 is the minute bar, labeling the minute values of the 3D time bar at the bottom of the display. The 3D view is created by establishing a vanishing point 2514 in the zoom canvas 102. All components of the time bar indicate an interval of time. In the case of the minute bar 2502, the interval is one minute, and the framing left and right lines indicating each minute of the minute bar fade towards the vanishing point 2514. The horizon line 2512 cuts all the separating lines 2520, before the lines reach the vanishing point. This establishes the horizon line 2512 as the largest time scale visualized on the zoom canvas 102. In the case of item 2500, the time bar at the front of the display 2502-2510 visualizes 20 minutes, while the horizon line 2512 visualizes 200 minutes. The hour bar 2504, the day bar 2506, the month bar 2508, and the year bar 2510, denote their respective timescales with the separating lines 2520 performing the same function for these bars as for the minute bar 2502. Item 2516 is the create alarm menu. When a user selects a period of time in the future, the create event menu options are available as in 2D versions of embodiments, items 1030 and 1032 seen on FIG. 10. In item 2500, the user has selected create alarm from the menu 1030 and the menu 2516 is visualized. Item 2518 is an alarm already created by a user and is located at 10:29 pm, Aug. 16, 2008 as defined by the time bar 2502-2510.

The location of the vanishing point 2514 and the horizon line 2512 are not necessarily fixed in the display. Both locations can be modified to change the way data is displayed and change the ratio of time on the time bar 2502-2510 and the horizon line 2512.

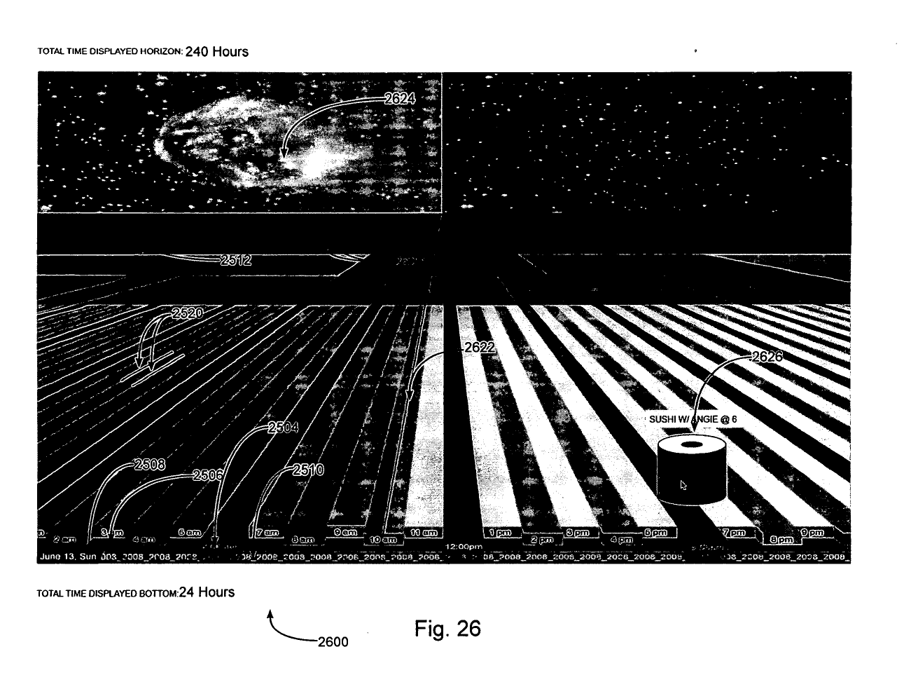

FIG. 26 and item 2600 are a visualization on a display in 3D mode. Item 2600 is at a further zoom level than item 2500. Item 2600 displays 24 hours on the time bar 2502-2510, and 240 hours on the horizon line 2512. Item 2500 visualizes an interval of time entirely in the future relative to a user. Item 2600 visualizes both past and future. This causes a “NOW” boundary 2622 to appear on the screen at the current time of a user. Item 2624 is the Backdrop, upon which data can be visualized. The section of the backdrop 2624 that is to the left of the “NOW” boundary 2622 is shaded to distinguish the past section of the backdrop from the future section of the backdrop. Item 2626 is an event icon visualizing a dinner meeting at 6:00 pm, Jun. 13, 2008. Items 2626 are day/month color bars that will help a user to understand the data displayed on the horizon line by indicating the time period and time scale visualized on the horizon line 2512.

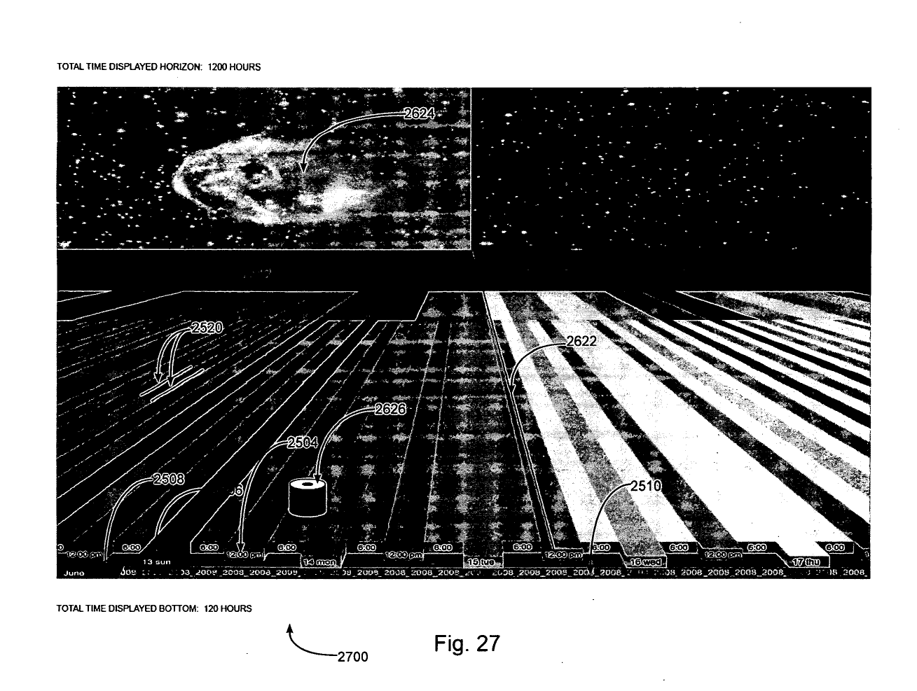

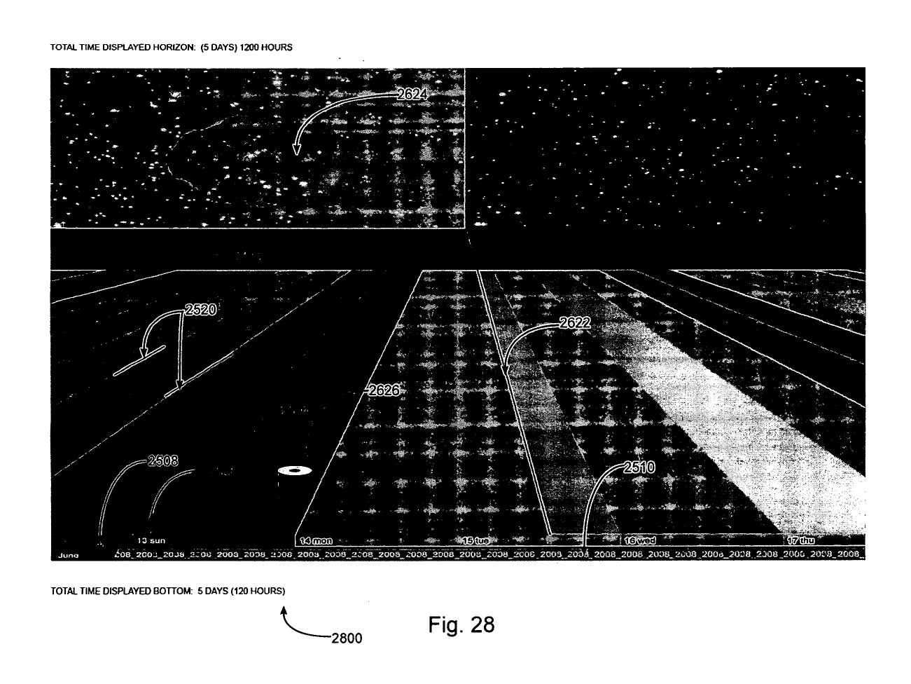

FIGS. 27 and 28 display the interface of an embodiment at the same scale: 120 hours at the time bar 2502-2510, and 1200 hours at the horizon line 2512. Items 2700 and 2800 are both depicting the interface at the same zoom level but this demonstrates a transition period for the hour bar 2504 to the day bar 2506. The drawings illustrate how an embodiment will start to fade out data as the zoom level becomes too great for a user to discern separation line 2520 distinctions.

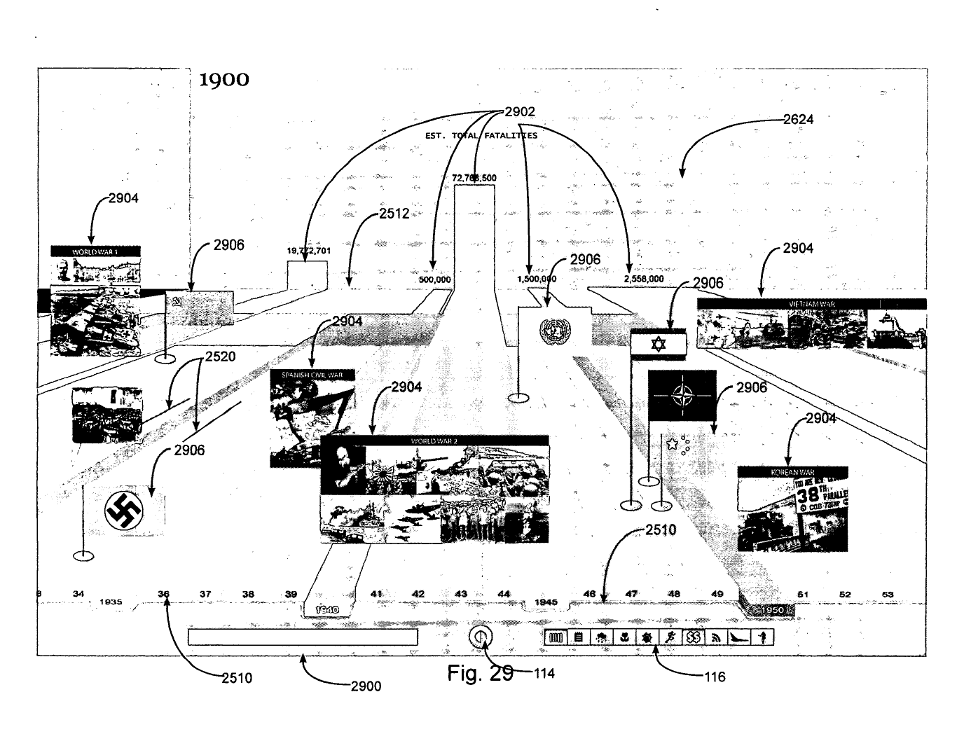

FIG. 29 and item 2900 are a visualization on a display by an embodiment operating in 3D mode. Item 2900 is displayed at a zoom level such that the time bar, 2502-2510 displays 20 years and the horizon line, 2512, displays 100 years. In this case, the backdrop, 2624 is all in the past. The items 2904 are bars representing the duration of the individual wars of the period shown on the zoom canvas. Each war, 2904, has a number of images within the war duration bar. The images are taken from online image depositories and added to the display by searching for images by keywords: all accomplished by this embodiment. Items 2902 display the total casualty count of each individual war, 2904. The width of each item 2902 is defined by the duration of the war aligned with the time intervals on the horizon line, 2512. Items 2906 indicate the rise of new governments in the time period displayed in item 2900. FIG. 29 demonstrates the visualization of one type of data set on the 3D mode of an embodiment. Embodiments, however, are not limited to showing historical data and all the data sets described above will also be potential data sets for visualization in the 3D zoom canvas.

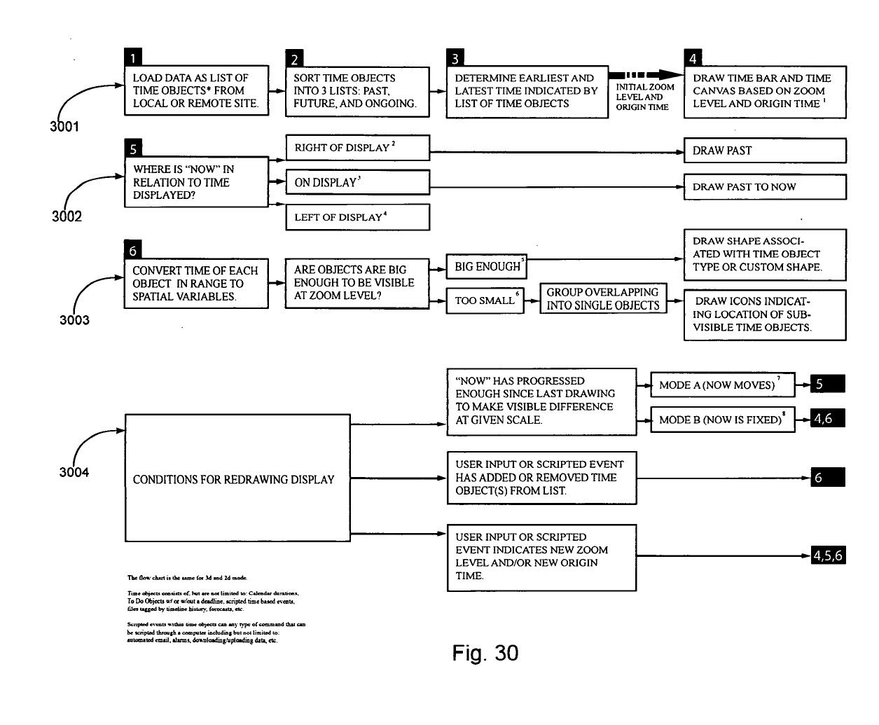

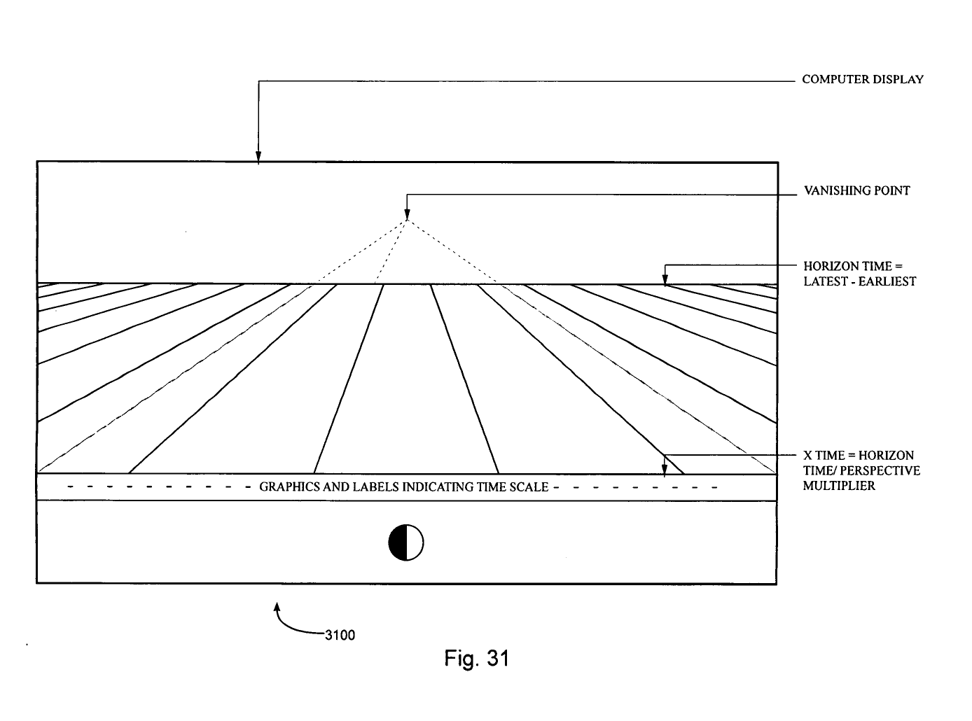

FIG. 30 is a block diagram of four exemplary systems that combine to create various embodiments. The block diagram indicated by item 3001 is a system that sorts a user's data and visualizes the time bar and zoom canvas 102 on a display. This system comprises a component for uploading a user's data, either from a local data storage device or a remote one. The system then sorts the data, based on the time-based parameter of the data and the user's current time, into items in the past, future, or ongoing. The next component of system 3001, checks the loaded data set for the earliest and latest time parameter associated with the data. The third component of system 3001 visualizes the time bar and zoom canvas based on the zoom level and the origin time. The origin time is the time selected by a user to be viewed at the far left of their display. FIG. 31 and item 3100 illustrate this last component of system 3001.

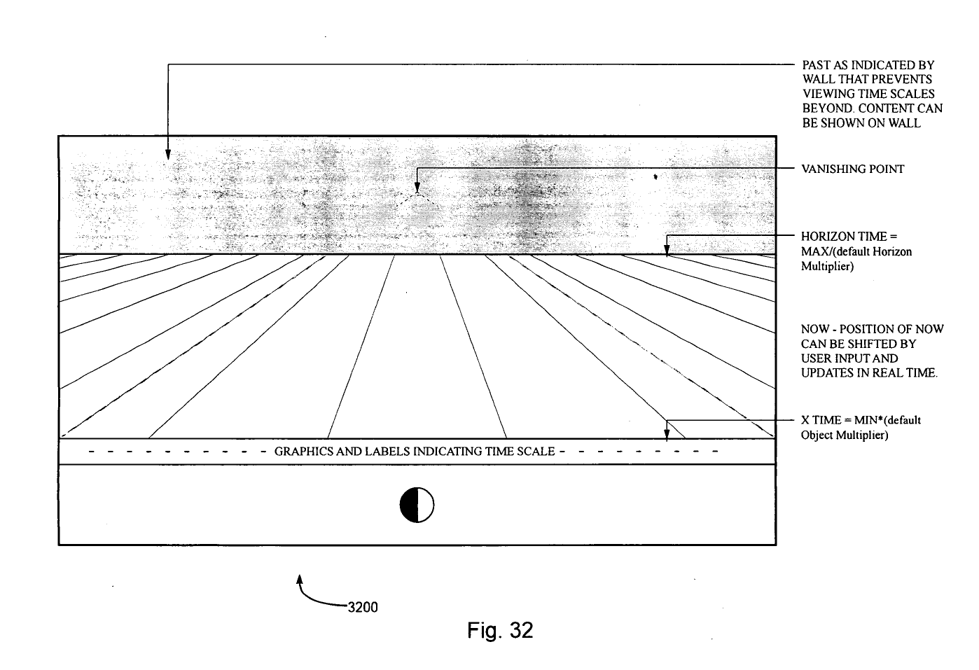

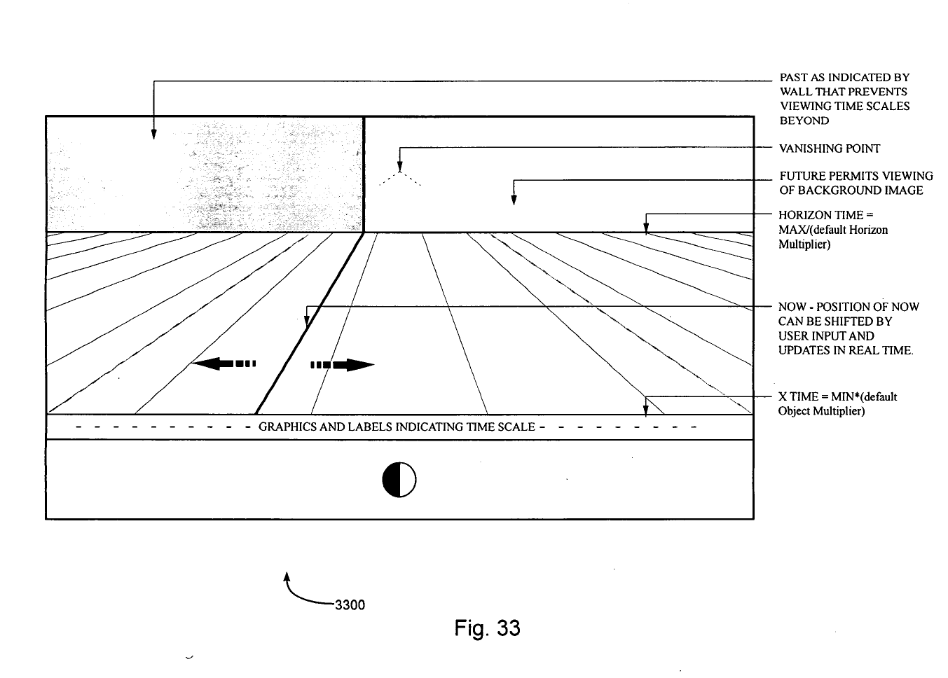

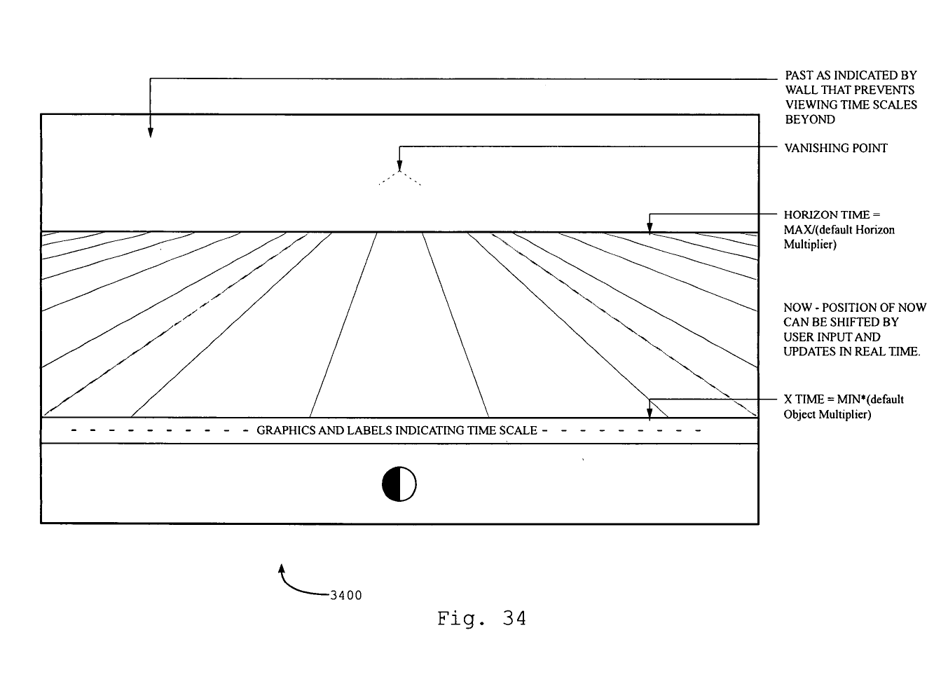

The next system on FIG. 30 is depicted by item 3002. The first component of system 3002 is determines the relationship between the visualized portion of time on the display, which is set by the zoom level and origin time selected by a user, and the users current time, or “NOW”. If “NOW” is to the right of the display, the system will draw items from the past. See FIG. 32 and item 3200 for an illustration of this component. If “NOW” is on the visualized display, then the system will draw items from the past to ongoing, to future. See FIG. 33 and item 3300 for an illustration of this component. If “NOW” is to the left of the display, the system will only draw items from the future. See FIG. 34 and item 3400 for an illustration of this component.

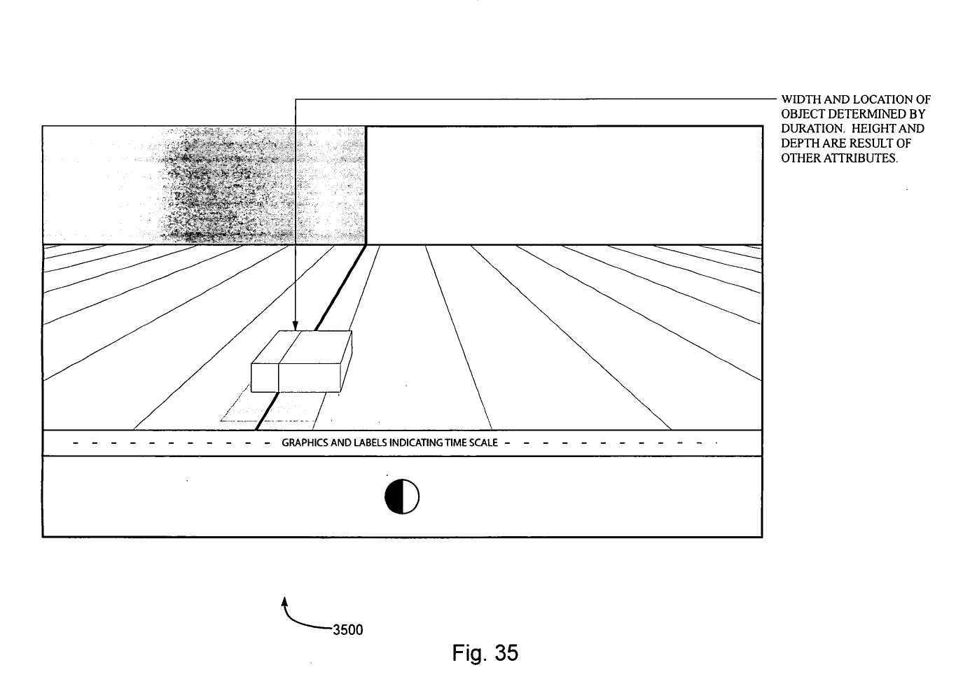

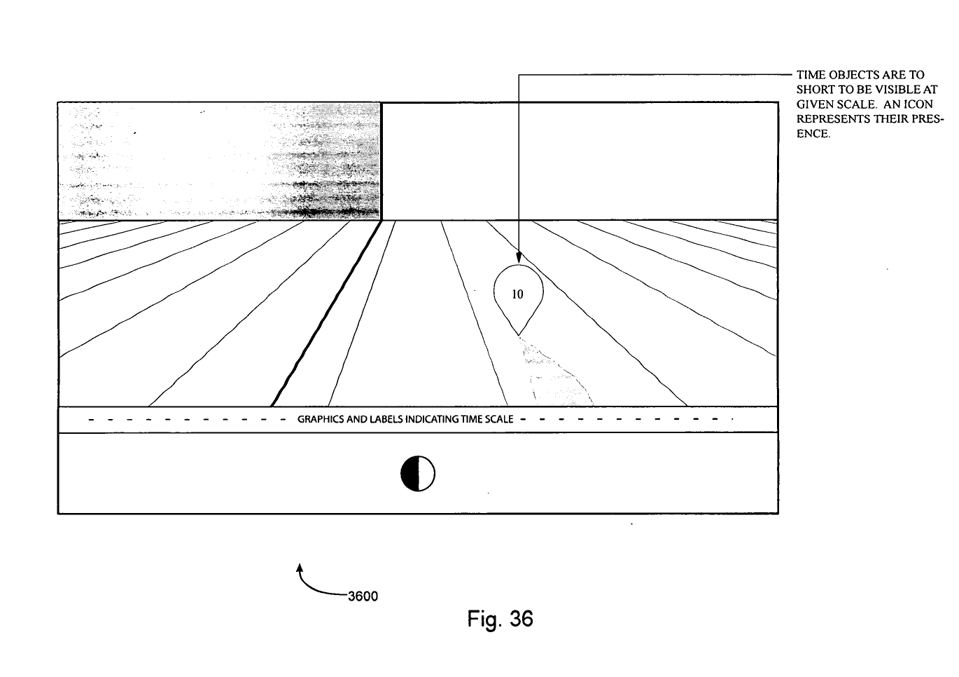

The next system on FIG. 30 is depicted by item 3003. The first component of system 3003 is to convert the time duration of a data object into the spatial dimensions that are set by a user's desired zoom level. For example, if the user wants to visualize one year on a display, and a data object has a six-month duration, the data object has a spatial dimension of 50% of the display's size. The next component of system 3003 determines if the data object has a large enough duration to be visible on the display. If yes, the system will draw the data object on the display. See FIG. 35 and item 3500 for an illustration of this component. If the data object is too small to see on the display, the system may tile any overlapping data objects and visualize the data objects on the display with icons. See FIG. 36 and item 3600 for an illustration of this component.

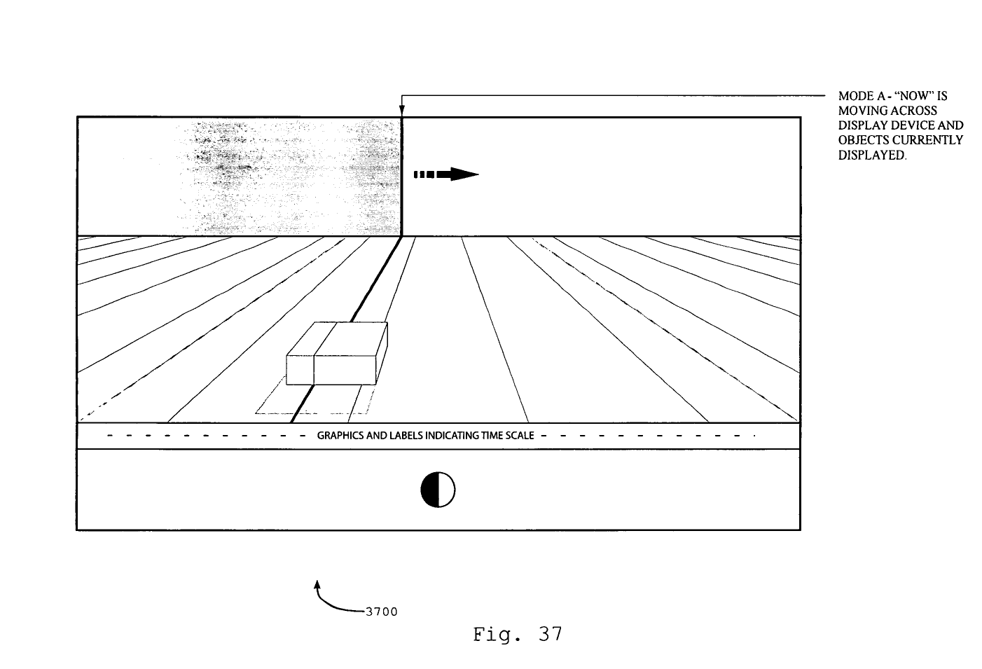

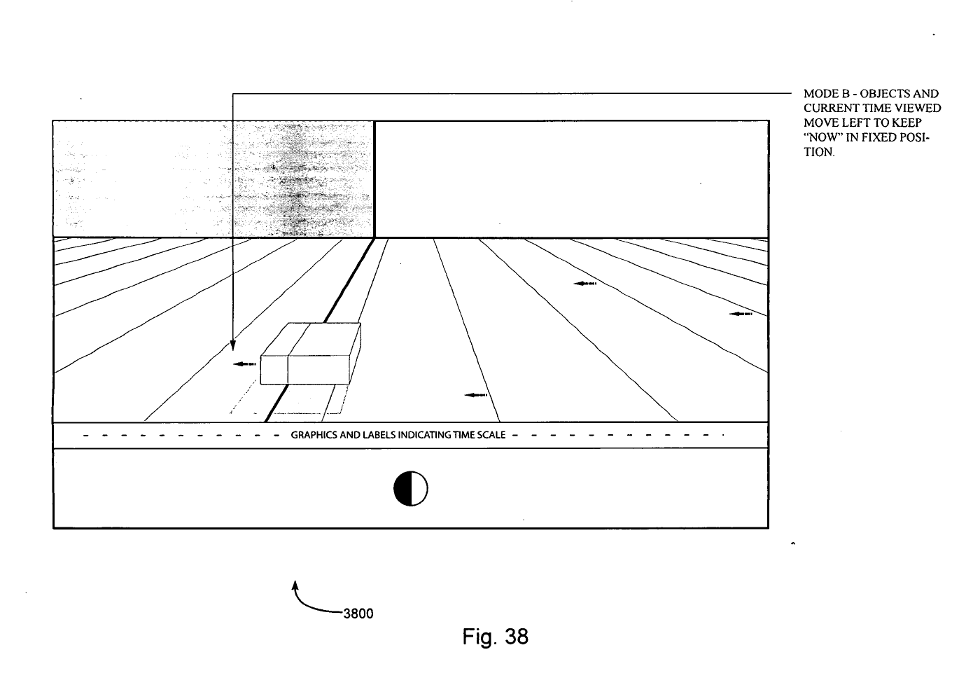

The next system on FIG. 30 is depicted by item 3004. System 3004 is a method to reduce the amount of processing required by setting threshold requirements for the display to be redrawn. The first threshold is if “NOW” has progressed enough since the last visualization of the display to make a visual difference at a user's selected zoom scale. If the user has selected to fix the time bar visually and allow “NOW” to move, this component is illustrated by FIG. 37 and 3700. In this instance, once the threshold is reached, system 3004 feeds the results back to system 3002. If the user has selected to fix “NOW” on the display and allowed the time bar to move, this component is illustrated by FIG. 38 and item 3800. In this instance, once the threshold is reached, system 3004 feeds the results back to system 3003. The second threshold is if a user or scripted event has added or removed a data object from the list of data objects to visualize. In this instance, once the threshold is reached, system 3004 feeds the results back to system 3003. The third threshold is if a user or scripted event changes the Zoom level or origin time to be visualized by this embodiment. In this instance, once the threshold is reached, system 3004 feeds the results back to system 3002, or 3003 based on the mode selected.

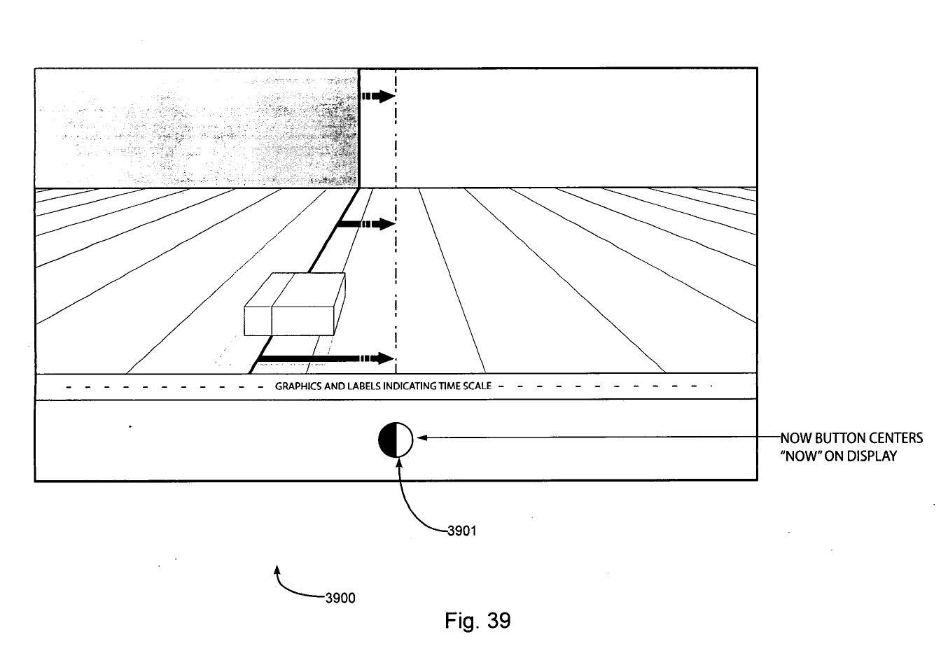

FIG. 39 and item 3900 depict the function of the “NOW” button, 3901. As it is depicted, the display 3900, shows the current time on line 3902. When a user selects the “NOW” button 3901, this embodiment redraws display 3900 so that the current time is visualized at the center of the screen 3903. Now the user's current time will be centered on the display. Based on the zoom level, the amount of time to display to the left and right of the current time is calculated. Selecting the “NOW” button, 3901, will not change the zoom level.

There are two general modes of operation of various embodiments. One mode is to have a set of time to visualize fixed on the display. In this mode “NOW” will move relative to the display. For instance, in this mode, if a user has selected to fix 1:00 pm, Aug. 2, 2008 on the left hand side of the screen and 2:00 pm, Aug. 2, 2008 on the right hand of the screen, “NOW” will appear to move left to right between 1 and 2 pm. The other display mode is to keep a user's current time, “NOW”, in the center of the screen, or some other position of the screen, and keep a certain amount of time visualized on either side of it. At a zoom level of 1 hour, there may always be 30 minutes visualized on either side of “NOW”. This mode necessitates the time bar and zoom canvas 102 to redraw to keep “NOW” in the middle of the screen. There are also some instances in which the system itself will switch between the two modes of operation. For example, if the system moves to idle, it may freeze the moment at which the user left the program on the left side of the screen and then proceed to zoom out so that when the user returns to the program, the user will see all the elapsed events since the system switched to idle. This requires the system to automatically shift from the mode of operation with “NOW” centered, to the mode of operation where “NOW” moves relative to the screen.

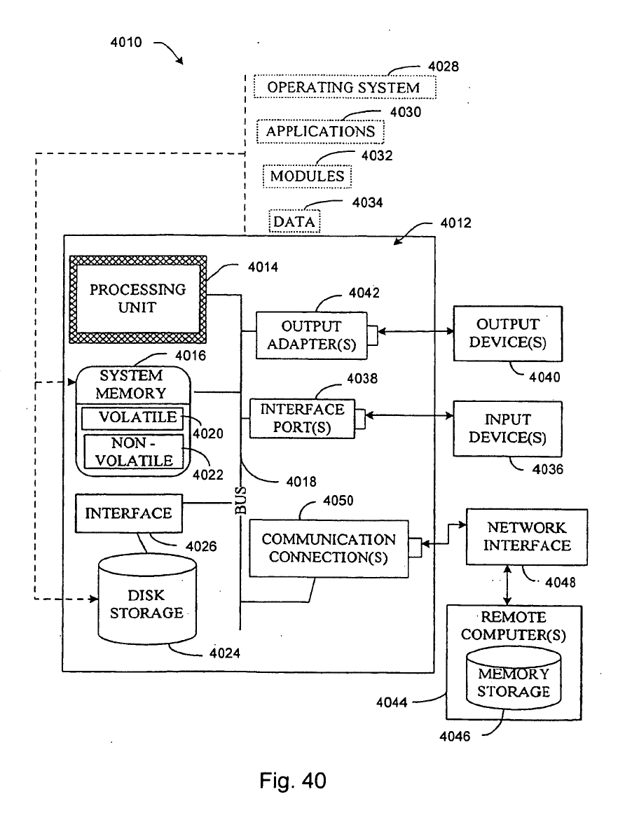

In order to describe additional context for various aspects of the subject embodiments, FIG. 40, and the following discussions are intended to provide a brief, general description of a suitable operating environment 4010 in which various embodiments may be implemented. While embodiments are described in the general context of computer-executable instructions, such as program modules, executed by one or more computers or other devices, those skilled in the art will recognize that embodiments can also be implemented in combination with other program modules and/or as a combination of hardware and software.

Generally, however, program modules include routines, programs, objects, components, data structures, etc. that perform particular tasks or implement particular data types. The operating environment 4010 is only one example of suitable operating environment and is not intended to suggest any limitation as to the scope of use or functionality of the embodiments. Other well known computer systems, environments, and/or configurations that may be suitable for use with the present embodiments include but are not limited to personal computers, hand held or laptop devices, multiprocessor systems, microprocessor-based systems, programmable consumer electronics, network PC's, minicomputers, mainframe computers, distributed computing environments that include the above systems or devices and the like.

With reference to FIG. 40, an exemplary environment 4010 for implementing various aspects includes a computer 4012. The computer 4012 includes a processing unit 4014, and a system memory 4016, a system bus 4018. The system bus 4018 couples system components including, but not limited to, the system memory 4016 to the processing unit 4014. The processing unit 4014 can be any of various available processors. Dual microprocessor architectures also can be employed as the processing unit 4014.

The system bus 4018 can be any of several types of bus structure(s) including the memory bus or memory controller, a peripheral bus or external bus, and/or a local bus using any variety of available bus architecture including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 4016 includes volatile memory 4020 and nonvolatile memory 4022. The basic input/output system (BIOS), containing the basic routines to transfer information between elements within the computer 4012, such as during start-up, is stored in nonvolatile memory 4022. By way of illustration, and not limitation, nonvolatile memory 4022 can include read only memory (ROM), programmable ROM (PROM), electrically programmable ROM (EPROM), electrically erasable ROM (EEPROM), or flash memory. Volatile memory 4020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct RAmbus RAM (DRRAM).

Computer 4012 also includes removable/nonremovable, volatile/nonvolatile computer storage media. FIG. 40 illustrates, for example a disk storage 4024. Disk storage 4024 includes, but is not limited to, devices like a magnetic disk drive, floppy disk drive, tape drive, Jaz drive, Zip drive, LS-100 drive, flash memory card, or memory stick. In addition, disk storage 4024 can include storage media separately on in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 4024 to the system bus 4018, a removable or non-removable interface is typically used such as interface 4026.

It is to be appreciated that FIG. 40 describes software that acts as an intermediary between users and the basic computer resources described in suitable operation environment 4010. Such software includes an operation system 4028. Operation system 4028, which can be stored on disk storage 4024, acts to control and allocate resources of the computer system 4012. System applications 4030 take advantage of the management of resources by operation system 4034 stored either in system memory 4016 or on disk storage 4024. It is to be appreciated that the present embodiments can be implemented with various operating systems or combinations of operating systems.

A user enters commands or information into the computer 4012 through input devices(s) 4036. Input devices 4036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 4014 through the system bus 4018 via interface port(s) 4038. Interface port(s) 4038 include, for example, a serial port, a parallel port, a game port, and a universal serial bus (USB). Output device(s) 4040 use some of the same type of ports as input device(s) 4036. Thus, for example, a USB port may be used to provide input to computer 4012, and to output information from computer 4012 to an output device 4040. Output adapter 4042 is provided to illustrate that there are some output devices 4040 that require special adapters. The output adapters 4042 include, by way of illustration and not limitation, video and sound cards that provide a means of connection between the output device 4040 and the system bus 4018. It should be noted that other devices and/or systems of devices provide both input and output capabilities such as remote computer(s) 4044.

Computer 4012 can operate in a networked environment using logical connections to one or more remote computers, such as remote computer(s) 4044. The remote computer(s) 4044 can be a personal computer, a server, a router, a network PC, a workstation, a microprocessor based appliance, a peer device or other common network n ode and the like, and typically includes many or all of the elements described relative to computer 4012. For purposes of brevity, only a memory storage device 4046 is illustrated with remote computer(s) 4044. Remote computer(s) 4044 is logically connected to computer 4012 through a network interface 4048 and then physically connected via communication connection 4050. Network interface 4048 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point to point links, circuit switching networks like Integrated Services Digital Networks (ISDN) and variations thereon, packet switching networks, and Digital Subscriber Lines (DSL).

Communication connection(s) 4050 refers to the hardware/software employed to connect the network interface 4048 to the bus 4018. While the communication connection 4050 is shown for illustrative clarity inside the computer 4012, it can also be external to computer 4012. The hardware/software necessary for connection to the network interface 4048 includes, for exemplary purposes only, internal and external technologies such as, modems including regular telephone grade modems, cable modems and DSL modems, ISDN adapters, and Ethernet cards.

Currently, the program is built in Adobe Flex and uses php to access online MySQL databases. The program can run in Adobe Flash or Adobe Air runtimes and these runtimes are available for Microsoft Windows PCs, Macintosh PCs, and Unix PCs.

What has been described above includes examples of preferred embodiments. It is, of course, not possible to describe every conceivable combination of components or methodologies for purposes of describing the embodiments, but one of ordinary skill in the art may recognize that many further combinations and permutations are possible. Accordingly, the present application is intended to embrace all such alterations, modifications, and variations that fall within the spirit and scope of the appended claims and any subsequent related claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for organizing data according to a time based parameter displayed on a linear axis, comprising:
a. Providing a visual user interface, the interface comprising a first area and a second area, the first area being larger than the second area, the second area comprising at least one bar extending horizontally and illustrating a time-line wherein earlier times are farther to the left and later times are farther to the right, wherein the image illustrated in the first area is determined based on selection by the user of a portion of the various times illustrated in the bar in the second area;
b. providing a memory which is able to store a series of data sets with time based parameters;
c. a segment of the display area for selecting the length and moment of time on the display.

2. The system of claim 1, further comprising a display of elements of the time, comprising:
a. visualizing each component of the date on the display;
b. a zooming mechanism that fits the full length of said component selected to the display;
whereby a user may select a component of the current date and zoom to the selected current date on said display.

3. The system of claim 1, further comprising a visualization of the selectable time components such that said components indicate the time items visualized on the display the time that said items are tied to.

4. The system of claim 1, further comprising a NOW button for centering the visualized display on the current time.

5. The system of claim 1, wherein the second area is divided by at least one unit selected from the following list: second, minute, hour, day, week, month, year, decade, and century, wherein each unit of time is selectable, whereby selecting any unit of time will redraw the first area whereby the first area will correspond to the unit of time selected.

6. The system of claim 1, further comprising a method for selling tickets, comprising
a. providing a controller which will:
i. allow a user to select a type of ticket to purchase;
ii. extract information via the world wide web concerning present tickets available based on the selection by the user of the type of ticket to purchase;
iii. visualizes available tickets for said user to purchase;
iv. allows said user to purchase desired tickets online.

7. The system of claim 1, further comprising a method for companies to bid on a user's allotted time, comprising:
a. identifying the user's time for vacation or any other activities via the world wide web and the companies accessing the available vacation time via the world wide web;
b. receiving said companies offer of a deal to said user;
c. said user accepting said deal via the world wide web.

8. A method for operating a personal organization system and sharing information, comprising:
a. inputting personal information into an electronic organization system by way of a user interface that is associated with the electronic organization system;
b. connecting the electronic organization system with the world wide web;
c. selecting at least one part of the personal information to be made available to third parties over the world wide web, whereby at least one third party user provides responsive information to the user through the electronic organization system by way of the world wide web.

9. The method of claim 8, wherein the user sends information to the third party in response to the information provided by the third party, the information provided in response by the user being transmitted over the world wide web.

10. The method of claim 8, wherein the personal information is at least one selected from the following list: date of vacation, time of vacation, duration of vacation, location of vacation, personal location, future location, desired activity, desired service, desired goods.

11. A computer system comprising:
a. a physical user interface;
b. a visual user interface having a first area and a second area;
c. the second area comprises at least two sequential time bars extending from left to right on the visual user interface, the bars representing a progression of time wherein an earlier time is farther to the left and a later time is farther to the right;
d. the first area illustrating a portion of time determined by a selection from the at least one of the sequential time bars.

12. The computer of claim 11, wherein a time bar is divided by at least one selected from the following list: second, minute, hour, day, week, month, year, decade, and century.

13. The computer of claim 12, wherein the user inputs personal information to the computer, the personal information being recorded on the computer.

14. The computer of claim 13, wherein the personal information is at least one selected from the following list: vacation time, vacation duration, vacation location, present location, future location, desired service, desired good, occupation and age.

15. The computer of claim 13, wherein the computer is connected with the world wide web and displays at least one part of the personal information to at least one third party over the world wide web when instructed to do so by the user by way of the user interface.

16. The computer of claim 13, wherein the categorized personal information is categorized based on at least one of the following: meal, activity, entertainment, vacation, work.

17. The computer of claim 16, wherein depending on the category of personal information, the world wide web is searched and an appropriate visual icon is selected to visually represent the personal information.

18. The computer of claim 15, wherein the user receives information from a third party by way of the world wide web, the information from the third party being in response to the personal information that is shared over the world wide web.

19. The computer of claim 15, wherein the personal information is location information obtained by a Global Positioning System associated with the computer.

20. The computer of claim 15, wherein distribution of the personal information over the world wide web can be scheduled in advance by the user using the user interface.
